(19) United States
(12) Patent Application Publication
(10) Pub. No.: US 2020/0324899 A1
(43) Pub. Date: Oct. 15, 2020

(54) SYSTEM AND METHODS FOR ELECTRONIC FENCES

(71) Applicant: SZ DJI TECHNOLOGY CO., LTD., Shenzhen (CN)

(72) Inventors: Chang Geng, Shenzhen (CN); Jian Zhao, Shenzhen (CN); Hongzhu Zhou, Shenzhen (CN); Yu Chen, Shenzhen (CN); Shunnian Li, Shenzhen (CN); Senyao Zheng, Shenzhen (CN)

(21) Appl. No.: 16/864,593

(22) Filed: May 1, 2020

Related U.S. Application Data
(63) Continuation of application No. PCT/CN2017/111676, filed on Nov. 17, 2017.

(51) Int. Cl. B64C 39/02; G05D 1/10

(52) U.S. Cl. CPC B64C 39/024; H04W 4/42; G05D 1/106

(57) ABSTRACT

A method for managing flight restricted regions for an unmanned aerial vehicle (UAV) includes an application processor receiving region information regarding the flight restricted regions from a database and processing the region information to obtain positional information of the flight restricted regions relative to the UAV, and a flight controller receiving the positional information of the flight restricted regions relative to the UAV and controlling flight of the UAV based on the received positional information. The flight controller is in communication with the application processor.

### CROSS-REFERENCE TO RELATED APPLICATION

This application is a continuation of International Application No. PCT/CN2017/111676, filed Nov. 17, 2017, the entire content of which is incorporated herein by reference.

### BACKGROUND

Aerial vehicles have a wide range of real-world applications including surveillance, reconnaissance, exploration, logistics transport, disaster relief, aerial photography, large-scale agriculture automation, live video broadcasting, etc. Increasingly, an aerial vehicle carrying a payload (e.g., a camera) may be subject to public and/or private flight regulations or flight restrictions. Flight restricted regions may comprise complex shapes and/or rules. The usefulness of aerial vehicles may be improved with appropriate distribution and/or utilization of processors for managing the flight restricted regions. The usefulness of aerial vehicles may be improved with appropriate management and/or division of the flight restricted regions.

### SUMMARY

Presently, unmanned aerial vehicles (UAV) may utilize a flight control module to control flight of UAVs around flight restricted regions. The flight control module may comprise a plurality of micro-controllers and various sensors may be coupled to the flight control module. In some instances, the flight control module may inefficiently process input data (e.g., regarding flight restricted regions). The ability to quickly locate and/or respond appropriately (e.g., with flight response measures) to flight restricted regions having complex shapes and heights may be desired.

Accordingly, a need exists for systems and methods that provides for the ability to abstract complex flight restricted regions, quickly locate flight restricted regions, and appropriately process flight restricted regions. Optionally, different processing modules may be provided for processing the flight restricted regions, and implementing appropriate flight response measures. The different processing modules may be coupled to different devices, sensors, and/or databases. An appropriate distribution of processing modules and ability for a subset or combination of the modules to work together to implement features may enable new and improved UAV functionality.

Accordingly, in one aspect, a method for managing flight restricted regions for an unmanned aerial vehicle (UAV) is provided. The method comprises: with aid of an application processor, receiving region information regarding the flight restricted regions from a database; processing the region information to obtain positional information of the flight restricted regions relative to the UAV; and with aid of a flight controller in communication with the application processor, receiving the positional information of the flight restricted regions relative to the UAV; and controlling flight of the UAV based on the received positional information.

In another aspect, a system for managing flight restricted regions for an unmanned aerial vehicle (UAV) is provided. The system comprises: an application processor configured to: receive region information regarding the flight restricted regions from a database; process the region information to obtain positional information of the flight restricted regions relative to the UAV based on the region information; and a flight controller in communication with the application processor, wherein the flight controller is configured to: receive the positional information of the flight restricted regions relative to the UAV; and control flight of the UAV based on the received positional information.

In another aspect, a method for storing simplified representations of flight restricted regions for an unmanned aerial vehicle (UAV) is provided. The method comprises: with aid of one or more processors: receiving information regarding a flight restricted region; processing the information regarding the flight restricted region to generate information regarding a simplified representation of the flight restricted region; and storing the information regarding the simplified representation of the flight restricted region in a database.

In another aspect, a system for storing simplified representations of flight restricted regions for an unmanned aerial vehicle (UAV) is provided. The system comprises: one or more processors, configured to: receive information regarding a flight restricted region; process the information regarding the flight restricted region to generate information regarding a simplified representation of the flight restricted region; and a database configured to: receive the information regarding the simplified representation of the flight restricted region; and store the information regarding the simplified representation of the flight restricted region.

In another aspect, a method for managing flight restricted regions for an unmanned aerial vehicle (UAV) is provided. The method comprises: with aid of one or more processors: locating, in a database, a simplified representation of a flight restricted region near the UAV; accessing information regarding a flight restricted region corresponding to the simplified representation of the flight restricted region near the UAV; generating a signal to control the UAV or a remote controller operably coupled to the UAV, wherein the signal is generated based on the flight restricted region, and not based on the simplified representation of the flight restricted region.

In another aspect, a system for managing flight restricted regions for an unmanned aerial vehicle (UAV) is provided. The system comprises: one or more processors configured to: locate, in a database, a simplified representation of a flight restricted region near the UAV; access information regarding a flight restricted region corresponding to the simplified representation of the flight restricted region near the UAV; generate a signal to control the UAV or a remote controller operably coupled to the UAV, wherein the signal is generated based on the flight restricted region, and not based on the simplified representation of the flight restricted region.

In another aspect, a method for dividing a flight restricted region for an unmanned aerial vehicle (UAV) is provided. The method comprises: with aid of an application processor, receiving information regarding the flight restricted region from a database; processing the information to divide the flight restricted region into two or more sub regions, wherein information regarding each of the two or more sub regions comprises less data than the information regarding the flight restricted region, and wherein a combination of the information regarding the two or more sub regions substantially reproduces the information regarding the flight restricted region.

In another aspect, a system for managing a flight restricted region for an unmanned aerial vehicle (UAV) is provided. The system comprises: an application processor configured to: receive information regarding the flight restricted region from a database; and process the information regarding the flight restricted region to generate information regarding two or more sub regions, wherein information regarding the two or more sub regions each comprises less data than the information regarding the flight restricted region, and wherein a combination of the information regarding the two or more sub regions substantially reproduces the information regarding the flight restricted region.

It shall be understood that different aspects of the disclosure can be appreciated individually, collectively, or in combination with each other. Various aspects of the disclosure described herein may be applied to any of the particular applications set forth below or for any other types of movable objects. Any description herein of an aerial vehicle may apply to and be used for any movable object, such as any vehicle. Additionally, the systems, devices, and methods disclosed herein in the context of aerial motion (e.g., flight) may also be applied in the context of other types of motion, such as movement on the ground or on water, underwater motion, or motion in space.

Other objects and features of the present disclosure will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates an area having a complex shape, in accordance with embodiments.

FIG. 2 illustrates flight restricted regions with simplified representations of flight restricted regions, in accordance with embodiments.

FIG. 3 illustrates a workflow of data for implementation of a flight response measure, in accordance with embodiments.

FIG. 4 illustrates a side view and a bottom view of a UAV relative to flight restricted regions, in accordance with embodiments.

FIG. 5 illustrates a UAV behavior adjacent to a flight restricted region, in accordance with embodiments.

FIG. 6 illustrates a method for managing flight restricted regions for a UAV, in accordance with embodiments.

FIG. 7 illustrates a method for storing simplified representations of flight restricted regions for a UAV, in accordance with embodiments.

FIG. 8 illustrates a method for managing flight restricted regions for an unmanned aerial vehicle, in accordance with embodiments.

FIG. 9 illustrates a method for operating a UAV in a flight restricted region, in accordance with embodiments.

FIG. 10 illustrates an unmanned aerial vehicle (UAV), in accordance with embodiments.

FIG. 11 is a schematic illustration by way of block diagram of a system for controlling a movable object, in accordance with embodiments.

FIG. 12 illustrates a method for dividing a flight restricted region for an unmanned aerial vehicle (UAV), in accordance with embodiments.

FIG. 13 illustrates an example of direction vectors generated for a flight restricted region, in accordance with embodiments.

FIG. 14 illustrates obtaining flight information based on positional information, in accordance with embodiments.

FIG. 15 illustrates various UAV behaviors in a vicinity of flight restricted regions, in accordance with embodiments.

### DETAILED DESCRIPTION

Systems, methods, and devices provided herein can be used to improve efficiency and operational capability of aerial vehicles. For example, the aerial vehicles and/or associated devices may be capable of handling flight restricted regions better. The aerial vehicles as used herein may refer to an unmanned aerial vehicle (UAV), or any other type of movable object. In some instances, a flight control module, also referred to herein as a flight controller, may be provided for controlling a flight of a UAV. For example, the flight control module may be responsible for generating one or more signals that effect movement of one or more propulsion units of the UAV, e.g., via ESC controllers. In some instances, the flight control module may lack sufficient computing capacity, may inefficiently process data, provide minimal hardware interface, lack software features, have poor scalability, and/or poor security. In some instances, flight restricted regions may have complicated shapes, heights, and/or flight response measures associated with them that make them difficult to process.

In some instances, additional processing modules may be provided for processing data or implementing features for the aerial vehicles. The additional processing modules may be utilized in conjunction with the flight control module. In some instances, the additional processing modules may comprise an application processing module. The application processing module(s), individually, or collectively, may also be referred to as an application processor. The application processing module may be provided on board the UAV. Alternatively or in addition, the application processing module may be provided on a remote controller or a mobile device operably coupled to the UAV. The application processing module may be configured to supplement and/or aid the flight control module. The application processing module may ensure a powerful computing capacity. In some instances, the application processing module may enable large operating system such as Android or Linux to be run on the UAV. Optionally, the application processing module may have real time processing capabilities, and/or high reliability. In some instances, the application processing module may be configured to run a plurality of different applications, depending on desired needs.

In some instances, the application processing module may be utilized to accomplish processing of data or implementation of functions that require heavy processing of data. In such instances, the application processing module may work with the flight control module to implement features of the UAV. In some instances, the features may relate to processing of flight restricted regions and/or implementing flight response measures.

Flight restricted regions as used herein may refer to any region within which it may be possible to limit or affect operation of an aerial vehicle. A flight restricted region, sometimes referred to as a flight restriction region, may also refer to an area and/or region associated with a flight response measure for an aerial vehicle. The aerial vehicle may be an unmanned aerial vehicle (UAV), or any other type of movable object. It may be desirable to limit the operation of UAVs in certain regions. For example, some jurisdictions may have one or more no-fly zones in which UAVs are not permitted to fly. In the U.S., UAVs may not fly within certain proximities of airports. Additionally, it may be prudent to restrict flight of aerial vehicles in certain regions. For example, it may be prudent to restrict flight of aerial vehicles in large cities, across national borders, near governmental buildings, and the like. For example, it may be desirable to limit flight within regions where flight conditions are known to be hazardous (e.g., known for strong winds, near borders, too far out from the shoreline, near important governmental buildings, etc.). For example, it may be desirable to limit flight within regions where a special (e.g., non-regular) event is taking place.

In some instances, a flight-restricted region may be a two-dimensional area, or may be defined by a two-dimensional area. For example, a flight-restricted region location may include an area or region.

The area or region may coincide with, mirror, or trace existing boundaries. The existing boundaries may, for example, be property boundary lines, national borders, boundary between states, natural boundaries (e.g., boundary between a body of water and land), and the like. The area or region may have any shape (e.g., rounded shape, rectangular shape, triangular shape, shape corresponding to one or more natural or man-made feature at the location, shape corresponding to one or more zoning rules, or any other boundaries). For example, the flight-restricted region may trace the boundaries of an airport, the border between nations, other jurisdictional borders, or any other type of boundaries.

The flight restricted regions may be defined by straight or curved lines. In some instances, the flight-restricted region may include a space. The space may be a three-dimensional space that includes latitude, longitude, and altitude coordinates. The three-dimensional space may include length, width, and height. The flight restricted region may have an altitude limit, such as an altitude floor and/or an altitude ceiling. The altitude limit for the flight restriction region may be constant over the flight restriction region. The altitude limit for the flight restriction region may change over the flight restriction region. For example, the altitude floor may increase as the distance from the center of the flight restriction region increases. The flight-restricted region may include space from the ground up to any altitude above the ground (e.g., predetermined altitude past which a UAV can fly or an altitude beyond which a UAV can fly). This may include altitude straight up from one or more flight-restricted region on the ground. For example, for some latitudes and longitudes, all altitudes may be flight restricted. In some instances, some altitudes for particular lateral regions may be flight-restricted, while others are not. For example, for some latitudes and longitudes, some altitudes may be flight restricted while others are not. Thus, the flight-restricted region may have any number of dimensions, and measurement of dimensions, and/or may be designated by these dimension locations, or by a space, area, line, or point representative of the region.

As mentioned herein, a flight restriction region may include any locations in which it may be desirable to limit operation of a UAV. For example, flight restriction regions may include one or more locations where unauthorized aerial vehicles may not fly. Other examples of types of flight restriction regions are provided further elsewhere herein. This may include unauthorized unmanned aerial vehicles (UAVs) or all UAVs. Flight-restricted regions may include prohibited airspace, which may refer to an area (or volume) of airspace within which flight of aircraft is not allowed, usually due to security concerns. Prohibited areas may contain airspace of defined dimensions identified by an area on the surface of the earth within which the flight of aircraft is prohibited. Such areas can be established for security or other reasons associated with the national welfare. These areas may be published in the Federal Register and are depicted on aeronautical charts in the United States, or in other publications in various jurisdictions. The flight-restricted region may include one or more of special use airspace (e.g., where limitations may be imposed on aircraft not participating in designated operations), such as restricted airspace (i.e., where entry is typically forbidden at all times from all aircraft and is not subject to clearance from the airspace's controlling body), military operations areas, warning areas, alert areas, temporary flight restriction (TFR) areas, national security areas, and controlled firing areas. The flight-restricted regions as used herein may also include any other airspace designated by a user and may be associated with a flight response measures. For example, a private property such as a residential or commercial building (or public property such as parks) may be designated as a flight restricted region.

Examples of flight-restricted regions may include, but are not limited to, airports, flight corridors, military or other government facilities, locations near sensitive personnel (e.g., when the President or other leader is visiting a location), nuclear sites, research facilities, private airspace, de-militarized zones, certain jurisdictions (e.g., townships, cities, counties, states/provinces, countries, bodies of water or other natural landmarks), national borders (e.g., the border between the U.S. and Mexico), private or public property, or any other types of zones. A flight-restricted region may be a permanent no-fly zone or may be a temporary area where flight is prohibited. A flight-restricted region may be an area where flight is allowed but is associated with a set of flight response measures. A list of flight-restricted regions may be updated. Flight-restricted regions may vary from jurisdiction to jurisdiction. For instance, some countries may include schools as flight-restricted regions while others may not.

In some instances, a flight restricted region may comprise shapes. The shapes may be two dimensional and/or three dimensional. In some instances, a shape of a flight restricted region may refer to a shape of a base portion (e.g., a shape as outlined on a ground or floor) of the flight restricted region. A flight restricted region may comprise a base portion having any shape. For example, a base portion of a flight restricted region may be circular, oval, polygonal (e.g., rectangular, etc.), or may be of an irregular shape or complex shape. In some instances, a flight restricted region may overlap with one another. In some instances, the flight restricted regions may border, but not overlap with one another.

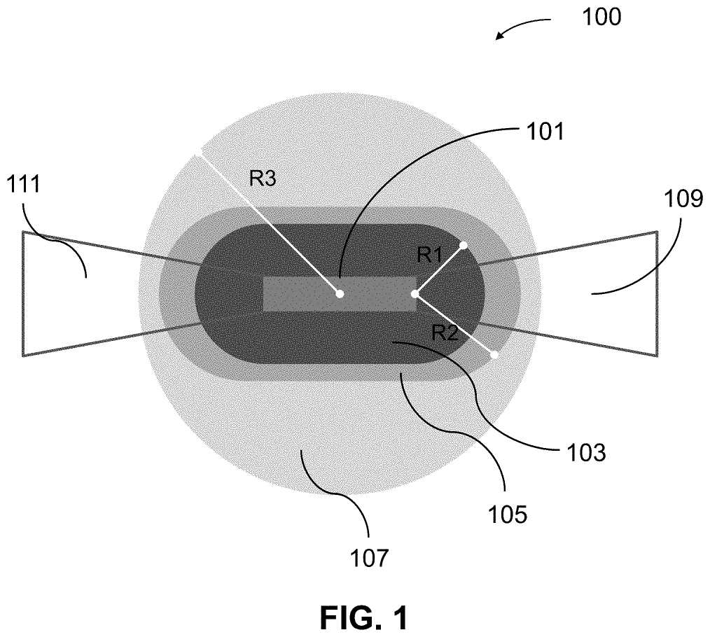

FIG. 1 illustrates an area having a complex shape 100, in accordance with embodiments. It may be desired to have a flight restricted region, or a plurality of flight restricted regions around a location 101. For example, the location 101 may be a runway of an airport. In some instances, the location may be associated with a flight restricted region having a complex shape, such as a candy shape illustrated in FIG. 1. Optionally, a complex shape may be parsed or divided into a plurality of different flight restricted regions 103, 105, 107, 109, and 111 as further described herein (e.g., for purposes of processing the flight restriction region). For example, a UAV passing by the location 101 may utilize one or more processors to process the complex shaped flight restricted region into the plurality of different flight restricted regions. Alternatively or in addition, the complex shaped flight restricted region may be divided into the plurality of different flight restricted regions within a database accessed by the UAV. Accordingly, the complex shaped flight restricted region may be pre-processed into a plurality of different flight restricted regions or may be processed into a plurality of different flight restricted regions substantially in real time, as the flight restricted region is encountered by the UAV.

In some instances, the complex shaped flight restricted region may be divided into a plurality of different flight restricted regions according to a flight response measure associated with it. As one example, the complex shaped flight restricted region may be divided into sub regions according to a height restriction (e.g., flight ceiling or flight floor). For example, flight restricted regions 103, 105, 107, and 109 may be part of a single complex flight restricted region 100 that is divided into sub-regions based on having different height restrictions. While dividing the flight restricted regions into sub regions based on different flight heights are primarily described herein, it is to be understood that a flight restricted region may be divided into a plurality of different flight restricted regions based on any flight response measure described herein. Alternatively or in addition, the flight restricted region may be divided into a plurality of different flight restricted regions based on an ease of processing. For example, a flight restricted region having a complex shape may be divided into a plurality of sub-regions each having a relatively simple shape, or a base portion in relatively simple shape. The shape of the base portion may for example, comprise regular shapes (e.g., circular, or polygonal shapes). In some instances, a flight restricted region may be divided into a plurality of sub-regions based on a first criteria, and further divided into additional regions based on a second criteria. As one example, if a given sub-region (e.g., divided based on different height restrictions) comprises a complex shape, it may be further divided such that sub-regions comprise only shapes of circles and/or polygons.

The plurality of flight restricted regions may be overlapping as illustrated. Each of the flight restricted regions may have a flight response measure associated with it, as further described below. Each of the flight restricted regions may have a same, or differing flight response measures associated with it.

Flight restricted region 103 may comprise a flight banned area. A movable object, such as a UAV may be prohibited from flying within the flight restricted region 103 altogether. In some instances, the flight restricted region 103 may be represented by a combination of circles and rectangles. For example, the flight restricted region 103 may comprise circles having a center at the two ends of the runway and having a predetermined radius R1 to make a circle at each side. The predetermined radius may be equal to or less than about 0.5 km, 1 km, 1.5 km, 2 km, 2.5 km, 3 km, 3.5 km, 4 km, 4.5 km, 5 km, 5.5 km, 6 km, 6.5 km, 7 km, 7.5 km, 8 km, 8.5 km, 9 km, 9.5 km, or 10 km. The flight restricted area 103 may further comprise a rectangle having four endpoints along the outer circumference of the aforementioned circles. Accordingly, flight restricted region 103 may be subdivided into 3 different regions, e.g., for purposes of processing by the UAV. Optionally, an application processor of the UAV may divide flight restricted region into the 3 different regions (e.g., aforementioned circles and rectangle) for purposes of determining flight restricted regions and calculating appropriate flight behavior for the UAV.

Flight restricted region 105 may comprise an area with a height limit. The height limit may be equal to or less than about 2 m, 5 m, 10 m, 15 m, 20 m, 25 m, 30 m, 35 m, 40 m, 45 m, or 50 m. A movable object, such as a UAV may be prohibited from flying above the flight restricted region 105 above the height limit. The flight restricted region 105 may encompass the flight restricted region 103. In some instances, the flight restricted region 105 may be represented by a combination of circles and rectangles. For example, the flight restricted region 105 may comprise circles having a center at the two ends of the runway and having a predetermined radius R2 to make a circle at each side. The predetermined radius may be equal to or less than about 3 km, 4 km, 5 km, 6 km, 7 km, 8 km, 9 km, 10 km, 11 km, 12 km, 13 km, 14 km, or 15 km. The flight restricted area 105 may further comprise a rectangle having four endpoints along the outer circumference of the aforementioned circles. Accordingly, flight restricted region 105 may be subdivided into 3 different regions, e.g., for purposes of processing by the UAV. In some instances, flight restricted regions 105 may comprise the aforementioned areas that are non-overlapping with flight restricted region 103. Optionally, an application processor of the UAV may divide flight restricted region into the 3 different regions (e.g., aforementioned circles and rectangle) for purposes of determining flight restricted regions and calculating appropriate flight behavior for the UAV.

Flight restricted region 109 and 111 may comprise an area with a height limit. The height limit may be equal to or less than about 10 m, 20 m, 30 m, 40 m, 50 m, 60 m, 70 m, 80 m, 90 m, 100 m, 110 m, or 120 m. A movable object, such as a UAV may be prohibited from flying above the flight restricted regions 109 and 111 above the height limit. The flight restricted regions 109 and 111 may each be represented by polygons, or trapezoids. For example, the flight restricted regions 109 and 111 may each comprise trapezoids formed by extending the runway by 15 km with divergent slopes of 15% to form a trapezoid. In some instances, flight restricted regions 109 and 111 may comprise the aforementioned areas that are non-overlapping with flight restricted regions 103 and/or 105.

Flight restricted region 107 may comprise an area with a height limit. The height limit may be equal to or less than about 20 m, 40 m, 60 m, 80 m, 100 m, 120 m, 140 m, 160 m, 180 m, 200 m, 220 m, 240 m, 260 m, 280 m, or 300 m. A movable object, such as a UAV may be prohibited from flying above the flight restricted region 107 above the height limit. The flight restricted region 107 may be presented by a circle. For example, the flight restricted region 107 may comprise an area defined by a circle having a center at the center of the runway and having a predetermined radius R3. The predetermined radius may be equal to or less than about 6 km, 8 km, 10 km, 12 km, 14 km, 16 km, 18 km, 20 km, 24 km, 26 km, or 28 km. In some instances, flight restricted region 107 may comprise the aforementioned areas that are non-overlapping with flight restricted regions 103, 105, 109, and/or 111.

Information regarding one or more flight-restricted regions may be stored on-board the UAV. Alternatively or in addition, information regarding one or more flight-restricted regions may be accessed from a data source off-board the UAV. For example, if the Internet or another network is accessible, the UAV may obtain information regarding flight restriction regions from a server online, e.g., cloud server. Optionally, the information regarding a flight restricted region may be of a complex flight restricted region (e.g., as shown in FIG. 1). A UAV may receive the information and process, or parse the flight restricted region into sub regions for ease of further processing, as described above. Information regarding the one or more flight restricted regions may comprise various parameters associated with the flight restricted regions. For example, the information may comprise one or more flight response measures associated with the flight restricted regions.

In some instances, the location of the UAV may be determined. This may occur prior to take-off of the UAV and/or while the UAV is in flight. In some instances, the UAV may have a GPS receiver that may be used to determine the location of the UAV. In other examples, the UAV may be in communication with an external device, such as a mobile control terminal. The location of the external device may be determined and used to approximate the location of the UAV. Optionally, the location of the UAV may be determined with aid of one or more sensors. The one or more sensors may be located on-board or off-board the UAV. In some instances, a combination of sensors on board and off board the UAV may be utilized to increase a degree of accuracy of determining a location of the UAV. Information about the location of one or more flight restricted regions accessed from a data source off-board the UAV may depend on, or be governed by a location of the UAV or an external device in communication with the UAV. For example, the UAV may access information on other flight-restricted regions about or within 1 mile, 2 miles, 5 miles, 10 miles, 20 miles, 50 miles, 100 miles, 200 miles, or 500 miles of the UAV. Information accessed from a data source off-board the UAV may be stored on a temporary or a permanent database. For example, information accessed from a data source off-board the UAV may add to a growing library of flight-restricted regions on board the UAV. Alternatively, only the flight restricted regions about or within 1 mile, 2 miles, 5 miles, 10 miles, 20 miles, 50 miles, 100 miles, 200 miles, or 500 miles of the UAV may be stored on a temporary database, and flight restricted regions previously within, but currently outside the aforementioned distance range (e.g., within 50 miles of the UAV) may be deleted. In some embodiments, information on all airports may be stored on-board the UAV while information on other flight-restricted regions may be accessed from a data source off-board the UAV (e.g., from an online server). The information, also referred to as region information, may be received by an application processor. The application processor may further process the region information to obtain positional information of flight restricted regions relative to the UAV. Optionally, positional information of each sub-region (e.g., sub-divided based on different height restrictions within the flight restricted region) may be obtained or determined by the application processor. Further, flight information may be derived from the positional information. The flight information may be derived by the application processor. Alternatively or in addition, the flight information may be derived by a flight controller. The flight information may ultimately control flight of the UAV as further described below. In some instances, the flight information may determine what flight response measures are to be taken. For example, if the UAV is within a flight prohibited region, the UAV may automatically land. In some instances, if the UAV is within a flight-restricted region, the operator of a UAV may be given a time period to land, after which the UAV will automatically land. In some instances, the UAV may provide an alert to an operator of the UAV regarding the proximity of the flight-restricted region. In some instances, if the UAV is within a particular distance from the flight-restricted region, the UAV may not be able to take off.

In some instances, it may be beneficial to provide different regions (e.g., flight restricted regions) with different flight restriction rules. The flight restriction rules may prescribe a set of flight response measures to be taken by the UAV, e.g., within the flight-restricted regions. For example, it may be advantageous to prohibit flight altogether in some flight-restriction regions. In some instances, it may sufficient to provide warnings to an operator of the UAV regarding a flight restriction region, but allow flight.

In some instances, the flight restricted regions may be associated with one or more flight response measures to be taken by the UAV. Operation of a UAV may be governed or affected by flight response measures (e.g., within flight restricted regions). A set of flight response measures may include one or more flight response measures. In some embodiments, a flight response measure may include preventing a UAV from entering the flight restriction region altogether. A UAV that ended up in the flight restriction region may be forced to land or forced to fly away from the flight restriction region. In some embodiments, a flight response measure may include allowing the UAV to remain in the flight restriction region, but imposing certain restrictions on the operation of the UAV within the flight restriction region. The UAV may be forced to remain within the flight restriction region. Various types and examples of flight response measures are described herein.

Flight response measures may govern physical disposition of the UAV. For instance, the flight response measures may govern flight of the UAV, take-off of the UAV, and/or landing of the UAV. In some examples, the flight response measures may prevent the UAV from flying within a flight restriction region. In some examples, the flight response measures may permit only a certain range of orientations of the UAV, or may not permit certain range of orientations of the UAV. The range of orientations of the UAV may be with respect to one, two, or three axes. The axes may be orthogonal axes, such as yaw, pitch, or roll axes. The physical disposition of the UAV may be governed with respect to a flight restriction region.

The flight response measures may govern movement of the UAV. For instance, the flight response measures may govern translational speed of the UAV, translational acceleration of the UAV, angular speed of the UAV (e.g., about one, two, or three axes), or angular acceleration of the UAV (e.g., about one, two, or three axes). The flight response measures may set a maximum limit for the UAV translational speed, UAV translational acceleration, UAV angular speed, or UAV angular acceleration. Thus, the set of flight response measures may comprise limiting flight speed and/or flight acceleration of the UAV. The flight response measures may set a minimum threshold for UAV translational speed, UAV translational acceleration, UAV angular speed, or UAV angular acceleration. The flight response measures may require that the UAV move between the minimum threshold and the maximum limit. Alternatively, the flight response measures may prevent the UAV from moving within one or more translational speed ranges, translational acceleration ranges, angular speed ranges, or angular acceleration ranges. In one example, a UAV may not be permitted to hover within a designated airspace. The UAV may be required to fly above a minimum translational speed of 0 mph. In another example, a UAV may not be permitted to fly too quickly (e.g., fly beneath a maximum speed limit of 40 mph). The movement of the UAV may be governed with respect to a flight restriction region.

The flight response measures may govern take-off and/or landing procedures for the UAV. For instance, the UAV may be permitted to fly, but not land in a flight restriction region. In another example, a UAV may only be able to take-off in a certain manner or at a certain speed from a flight restriction region. In another example, manual take-off or landing may not be permitted, and an autonomous landing or take-off process must be used within a flight restriction region. The flight response measures may govern whether take-off is allowed, whether landing is allowed, any rules that the take-off or landing must comply with (e.g., speed, acceleration, direction, orientation, flight modes). In some embodiments, only automated sequences for taking off and/or landing are permitted without permitting manual landing or take-off, or vice versa. The take-off and/or landing procedures of the UAV may be governed with respect to a flight restriction region.

In some instances, the flight response measures may govern operation of a payload of a UAV. The payload of the UAV may be a sensor, emitter, or any other object that may be carried by the UAV. The payload may be powered on or off. The payload may be rendered operational (e.g., powered on) or inoperational (e.g., powered off). Flight response measures may comprise conditions under which the UAV is not permitted to operate a payload. For example, in a flight restriction region, the flight response measures may require that the payload be powered off. The payload may emit a signal and the flight response measures may govern the nature of the signal, a magnitude of the signal, a range of the signal, a direction of signal, or any mode of operation. For example, if the payload is a light source, the flight response measures may require that the light not be brighter than a threshold intensity within a flight restriction region. In another example, if the payload is a speaker for projecting sound, the flight response measures may require that the speaker not transmit any noise outside a flight restriction region. The payload may be a sensor that collects information, and the flight response measures may govern a mode in which the information is collected, a mode about how information is pre-processed or processed, a resolution at which the information is collected, a frequency or sampling rate at which the information is collected, a range from which the information is collected, or a direction from which the information is collected. For example, the payload may be an image capturing device. The image capturing device may be capable of capturing static images (e.g., still images) or dynamic images (e.g., video). The flight response measures may govern a zoom of the image capturing device, a resolution of images captured by the image capturing device, a sampling rate of the image capturing device, a shutter speed of the image capturing device, an aperture of the image capturing device, whether a flash is used, a mode (e.g., lighting mode, color mode, still vs. video mode) of the image capturing device, or a focus of the image capturing device. In one example, a camera may not be permitted to capture images in over a flight restriction region. In another example, a camera may be permitted to capture images, but not capture sound over a flight restriction region. In another example, a camera may only be permitted to capture high-resolution photos within a flight restriction region and only be permitted to take low-resolution photos outside the flight restriction region. In another example, the payload may be an audio capturing device. The flight response measures may govern whether the audio capture device is permitted to be powered on, sensitivity of the audio capture device, decibel ranges the audio capture device is able to pick up, directionality of the audio capture device (e.g., for a parabolic microphone), or any other quality of the audio capture device. In one example, the audio capture device may or may not be permitted to capture sound within a flight restriction region. In another example, the audio capture device may only be permitted to capture sounds within a particular frequency range while within a flight restriction region. The operation of the payload may be governed with respect to a flight restriction region.

The flight response measures may govern whether a payload can transmit or store information. For instance, if the payload is an image capturing device, the flight response measures may govern whether images (still or dynamic) may be recorded. The flight response measures may govern whether the images can be recorded into an on-board memory of the image capture device or a memory on-board the UAV. For instance, an image capturing device may be permitted to be powered on and showing captured images on a local display, but may not be permitted to record any of the images. The flight response measures may govern whether images can be streamed off-board the image capture device or off-board the UAV. For instance, flight response measures may dictate that an image capture device on-board the UAV may be permitted to stream video down to a terminal off-board the UAV while the UAV is within a flight restriction region, and may not be able to stream video down when outside a flight restriction region. Similarly, if the payload is an audio capture device, the flight response measures may govern whether sounds may be recorded into an on-board memory of the audio capture device or a memory on-board the UAV. For instance, the audio capture device may be permitted to be powered on and play back captured sound on a local speaker, but may not be permitted to record any of the sounds. The flight response measures may govern whether the images can be streamed off-board the audio capture device, or any other payload. The storage and/or transmission of collected data may be governed with respect to a flight restriction region.

In some instances, the payload may be an item carried by the UAV, and the flight response measures may dictate the characteristics of the payload. Examples of characteristics of the payload may include dimensions of the payload (e.g., height, width, length, diameter, diagonal), weight of the payload, stability of the payload, materials of the payload, fragility of the payload, or type of payload. For instance, the flight response measures may dictate that the UAV may carry the package of no more than 3 lbs while flying over a flight restriction region. In another example, the flight response measures may permit the UAV to carry a package having a dimension greater than 1 foot only within a flight restriction region. Another flight response measures may permit a UAV to only fly for 5 minutes when carrying a package of 1 lb or greater within a flight restriction region, and may cause the UAV to automatically land if the UAV has not left the flight restriction region within the 5 minutes. Restrictions may be provided on the type of payloads themselves. For example, unstable or potentially explosive payloads may not be carried by the UAV. Flight restrictions may prevent the carrying of fragile objects by the UAV. The characteristics of the payload may be regulated with respect to a flight restriction region.

Flight response measures may also dictate activities that may be performed with respect to the item carried by the UAV. For instance, flight response measures may dictate whether an item may be dropped off within a flight restriction region. Similarly flight response measures may dictate whether an item may be picked up from a flight restriction region. A UAV may have a robotic arm or other mechanical structure that may aid in dropping off or picking up an item. The UAV may have a carrying compartment that may permit the UAV to carry the item. Activities relating to the payload may be regulated with respect to a flight restriction region.

Positioning of a payload relative to the UAV may be governed by flight response measures. The position of a payload relative to the UAV may be adjustable. Translational position of the payload relative to the UAV and/or orientation of the payload relative to the UAV may be adjustable. Translational position may be adjustable with respect to one, two, or three orthogonal axes. Orientation of the payload may be adjustable with respect to one, two, or three orthogonal axes (e.g., pitch axis, yaw axis, or roll axis). In some embodiments, the payload may be connected to the UAV with a carrier that may control positioning of the payload relative to the UAV. The carrier may support the weight of the payload on the UAV. The carrier may optionally be a gimbaled platform that may permit rotation of the payload with respect to one, two, or three axes relative to the UAV. One or more frame components and one or more actuators may be provided that may effect adjustment of the positioning of the payload. The flight response measures may control the carrier or any other mechanism that adjusts the position of the payload relative to the UAV. In one example, flight response measures may not permit a payload to be oriented facing downward while flying over a flight restriction region. For instance, the region may have sensitive data that it may not be desirable for the payload to capture. In another example, the flight response measures may cause the payload to move translationally downward relative to the UAV while within a flight restriction region, which may permit a wider field of view, such as panoramic image capture. The positioning of the payload may be governed with respect to a flight restriction region.

The flight response measures may govern the operation of one or more sensors of an unmanned aerial vehicle. For instance, the flight response measures may govern whether the sensors are turned on or off (or which sensors are turned on or off), a mode in which information is collected, a mode about how information is pre-processed or processed, a resolution at which the information is collected, a frequency or sampling rate at which the information is collected, a range from which the information is collected, or a direction from which the information is collected. The flight response measures may govern whether the sensors can store or transmit information. In one example, a GPS sensor may be turned off while a UAV is within a flight restriction region while vision sensors or inertial sensors are turned on for navigation purposes. In another example, audio sensors of the UAV may be turned off while flying over a flight restriction region. The operation of the one or more sensors may be governed with respect to a flight restriction region.

Communications of the UAV may be controlled in accordance with one or more flight response measures. For instance, the UAV may be capable of remote communication with one or more remote devices. Examples of remote devices may include a remote controller that may control operation of the UAV, payload, carrier, sensors, or any other component of the UAV, a display terminal that may show information received by the UAV, a database that may collect information from the UAV, or any other external device. The remote communications may be wireless communications. The communications may be direct communications between the UAV and the remote device. Examples of direct communications may include WiFi, WiMax, radio-frequency, infrared, visual, or other types of direct communications. The communications may be indirect communications between the UAV and the remote device which may include one or more intermediary device or network. Examples of indirect communications may include 3G, 4G, LTE, satellite, or other types of communications. The flight response measures may dictate whether remote communications are turned on or off. Flight response measures may comprise conditions under which the UAV is not permitted to communicate under one or more wireless conditions. For example, communications may not be permitted while the UAV is within a flight restriction region. The flight response measures may dictate a communication mode that may or may not be permitted. For instance, the flight response measures may dictate whether a direct communication mode is permitted, whether an indirect communication mode is permitted, or whether a preference is established between the direct communication mode and the indirect communication mode. In one example, only direct communications are permitted within a flight restriction. In another example, over a flight restriction region, a preference for direct communications may be established as long as it is available, otherwise indirect communications may be used, while outside a flight restriction region, no communications are permitted. The flight response measures may dictate characteristics of the communications, such as bandwidth used, frequencies used, protocols used, encryptions used, devices that aid in the communication that may be used. For example, the flight response measures may only permit existing networks to be utilized for communications when the UAV is within a predetermined volume. The flight response measures may govern communications of the UAV with respect to a flight restriction region.

Other functions of the UAV, such as navigation, power usage and monitoring, may be governed in accordance with flight response measures. Examples of power usage and monitoring may include the amount of flight time remaining based on the battery and power usage information, the state of charge of the battery, or the remaining amount of estimated distance based on the battery and power usage information. For instance, the flight response measures may require that a UAV in operation within a flight restriction region have a remaining battery life of at least 3 hours. In another example, the flight response measures may require that the UAV be at least at a 50% state of charge when outside a flight restriction region. Such additional functions may be governed by flight response measures with respect to a flight restriction region.

As described above, information regarding a flight restricted region may be stored in a data source, also referred to herein as a database. The database may be a database for recording or storing parameters associated with a flight restricted region. The parameters as described herein may comprise or include region information described above. The database may be a database hosted on a website or an online server. The database may be operatively coupled to one or more memory units. The database may be periodically, continuously, and/or optionally updated. For example, the database may be updated at predetermined time intervals. In some instances, the database may be updated by an entity controlling the database. Alternatively or in addition, the database may be updated by other entities (e.g., governmental entities, users of UAVs, or people with a claim to a specific region or area over which a flight restricted region is to be maintained, etc.).

The database may comprise information associated with UAVs, users of UAVs, and/or flight restricted regions. For example, the database may comprise parameters associated with the flight restriction regions. The parameters of flight restriction regions may include any information that is related to the flight restriction region. For example, the parameters may include a location, type (e.g., category), status (e.g., update date, upload date, etc.), radius or boundaries, height, length, width, circumference, diameter, altitude limit (e.g., altitude ceiling and/or altitude floor), duration, time period of flight restriction regions, or flight response measure associated with flight restriction regions.

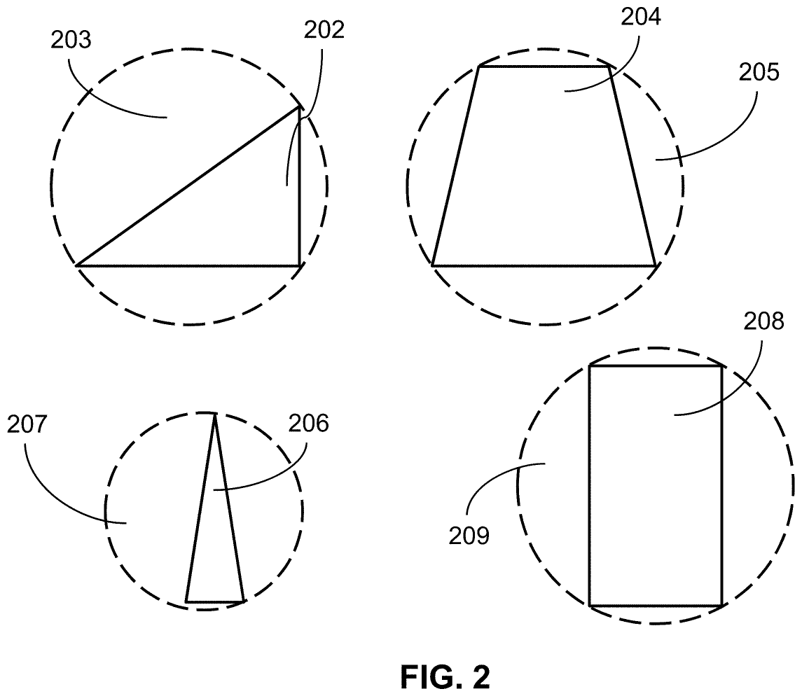

Optionally, the parameters may include data relating to a simplified representation of a flight restricted region, as further described herein. FIG. 2 illustrates flight restricted regions with simplified representations of flight restricted regions, in accordance with embodiments. Flight restricted regions 202, 204, 206, and 208 may be actual flight restricted regions. The flight restricted regions may be associated with a flight response measure for a UAV. For example, UAVs may be barred from entering the flight restricted regions, or may be restricted from flying above a certain height within the flight restricted regions. The flight restricted region may have a complex shape. In some instances, the flight restricted region may have a polygonal shape.

A given flight restricted region may have a simplified representation of the flight restricted region associated with it. In some instances, the simplified representation of the flight restricted region may be stored in the database. Optionally, the simplified representation of the flight restricted region may be stored in the database as a parameter associated with the flight restricted region. In some instances, the simplified representation of the flight restricted region may be (or may be represented or defined by) a circumscribed circle for the flight restricted region. The circumscribed circle for the flight restricted region may be a circle which passes through all the vertices of the flight restricted region. For example, the simplified representations of flight restricted regions 203, 205, and 209 show circumscribed circles for corresponding flight restricted regions 202, 204, and 208. Alternatively or in addition, the simplified representation of the flight restricted region may be (or may be represented or defined by) a minimum covering circle for the flight restricted region. The minimum covering circle for the flight restricted region may be the smallest circle that contains all of a given set of points (e.g., vertices) of the flight restricted region. For example, the simplified representation of a flight restricted region 207 shows a minimum covering circle for corresponding flight restricted region 206. Having data associated with a simplified representation of a flight restricted region may aid in quickly searching and/or locating flight restricted regions as further described herein.

In some instances, the parameters (e.g., region information) may alternatively, or in addition, include an area id, latitude, longitude, radius, shape, sub area id, height, area level, country, and/or points. Each of the aforementioned parameters may be a parameter associated with the flight restricted region itself. Alternatively or in addition, the parameters may be a parameter associated with a simplified representation of the flight restricted region.

The area id may be an id for a geospatial area the flight restricted region is located in. The area id may be unique. The area id may be a serial number. The latitude may be a latitude of a center of a circle with a minimum shape cover which covers the flight restricted region (e.g., covers the base portion of the flight restriction region). As one example, the latitude may be a latitude of a center of the simplified representation of a flight restricted region described above in FIG. 2. Alternatively, the latitude may be a latitude of the actual flight restricted region. The longitude may be a longitude of a center of a circle with a minimum shape cover which covers the flight restricted region (e.g., covers the base portion of the flight restricted region). As one example, the longitude may be a longitude of a center of the simplified representation of a flight restricted region described above in FIG. 2. Alternatively, the longitude may be a longitude of the actual flight restricted region. The radius may be a radius of the circle (e.g., the above referenced circle having the recited latitude and/or longitude). As one example, the radius may be a radius of the simplified representation of a flight restricted region described above in FIG. 2. Alternatively, the radius may be a radius of the actual flight restricted region. The shape may refer to a shape of the flight restricted region. In some instances, the shape may be a circle, a single polygon, and/or a group of polygons. The sub area id may refer to an id for a geospatial area a subunit of the flight restricted region is located at. The sub area id may be used for representing a serial number of a sub-polygon if a group of polygons are used to represent a flight restricted region (e.g., as described in FIG. 1). The height may refer to a height information of the flight restricted region, such as altitude ceiling and/or floor. The area level may refer to the level of flight restricted region, or a category of the flight restricted region. The country may refer to the country to which the flight restricted region belongs. The points may refer to the geospatial information of the vertex of the flight restricted region. In some instances, the points may contain geographic coordinates of each point of the base portion of the flight restricted region. The geographic coordinates may comprise a longitude and/or latitude of vertices of the flight restricted region. The geographic coordinates may in some instances be expressed by a structure in which the number of the points and coordinates of latitude and longitude of each point are ranked in order.

As discussed above, the parameters of flight restriction regions may include a location of the flight restriction region. The location may include a local or global coordinate (e.g., latitude and/or longitude), nation, city, street address, street intersection, name (e.g., identifiable name associated with the region such as JFK Airport, The White House, Dolores Park, The Golden Gate Bridge), etc., of the flight restriction region. The location of the flight restricted region may represent a single location (e.g., a latitude and/or a longitude). Alternatively, the location of the flight restricted region may be represented by a plurality of points, e.g., for a polygonal flight restricted region. For example, a rectangular shaped flight restricted region may be represented by four points, or four different locations each having a latitude and/or longitude. The four points may further be associated with a rank (e.g., 1, 2, 3, 4, 5, etc.). The rank may in some instances be associated with how the flight restricted region is shaped, or may be created. For example, for a flight restricted region having a polygonal shape, a point having the first rank may be connected to a point having the second rank and the last rank, but not intermediate ranks. In some instances, for a polygonal flight restricted region, a given point having x rank may be configured to be connected to points having x−1 and x+1, where if x−1=0, the point is connected to the last ranked point.

The parameters of flight restriction regions may designate a shape of the two- or three-dimensional space of flight restriction regions. The shape may include any shape such as a circle, oval, semi-circle, polygon, triangle, rectangle, square, octagon, etc. For example, the two-dimensional space may be defined by a circle centered at the location. For example, a three-dimensional space may be defined by a cylinder with a base portion centered at the location and extending from the altitude floor to the altitude ceiling. Other exemplary shapes of the three-dimensional may include, but not be limited to, sphere, semi-sphere, cube, rectangular prism, irregular shapes, and the like.

The parameter of flight restriction regions may include a set of flight response measures desired of a flight restriction region. Operation of a UAV may be governed or affected by flight response measures, as described above. A set of flight response measures may include one or more flight response measures. In some embodiments, a flight response measure may include preventing a UAV from entering the flight restriction region altogether. A UAV that ended up in the flight restriction region may be forced to land or forced to fly away from the flight restriction region. In some embodiments, a flight response measure may include allowing the UAV to remain in the flight restriction region, but imposing certain restrictions on the operation of the UAV within the flight restriction region. The UAV may be forced to remain within the flight restriction region. Various types and examples of flight response measures are described above.

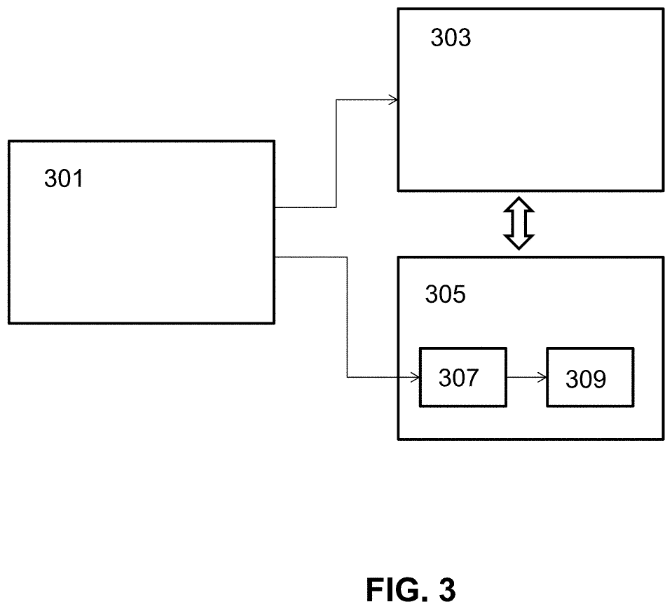

FIG. 3 illustrates a workflow of data for implementation of a flight response measure, in accordance with embodiments. A database 301, remote controller 303, and/or UAV 305 may be involved, amongst others, in implementing a flight response measure for a UAV. As described above, the database may be hosted on an online server. Optionally, the database may utilize peer to peer communication protocols, and/or may be hosted on a cloud. In some instances, the database may communicate with a UAV and/or a remote controller, e.g., via wired or wireless communication modules. In some instances, the database may transmit information (e.g., region information) regarding flight restricted regions to the UAV and/or remote controller. For example, the database may transmit information regarding parameters associated with flight restricted regions. Each of the UAV and/or remote controller may further comprise its own database for storing information regarding the flight restricted regions. In some instances, the UAV and/or remote controller may comprise a memory for storing the information regarding the flight restricted regions. Optionally, the memory may be located on board the UAV.

As used herein, a remote controller may refer, individually or collectively, to devices configured to affect operation of the UAV. For example, the remote controller may comprise a display for viewing operations related to the UAV such as an iPad or a tablet. Alternatively or in addition, a remote controller may comprise a physical controller with control sticks that affect operation of the UAV. In some instances, the remote controller may be configured to store information relating to display of the flight restricted regions. In some instances, the remote controller may store information relating to display of flight restricted regions. Optionally, the remote controller may store a full version of a display database. Optionally, the display database may comprise region information regarding flight restricted regions without the simplified representation of the flight restricted regions. The database of the remote controller may in some instances be optimized for storing information relating to display of the flight restricted regions. Accordingly, data stored in the remote controller database may be accessed such that information regarding the flight restricted regions can be quickly rendered and displayed on the remote controller.

The UAV may in some instances store a full version of the database 301. The database of the UAV may optionally be optimized for processing of flight-restricted logic. As discussed herein, each of the databases of the remote controller and/or the UAV may be generated by the database 301 (e.g., server). The database 301 may comprise a release version, and may release a version to each of the remote controller and UAV. In some instances, the remote controller and UAV may version match databases to verify that the databases are the same, or up to date.

Optionally, the database of each of the remote controller and the UAV may be independently upgraded. For example, the database of the UAV may be updated independently of the remote controller. Only the database of the UAV may be utilized in considering flight restricted regions. For example, the database on the remote controller end may be utilized for the purpose of displaying to a user the flight restricted regions but may not be utilized in actually considering flight restricted regions by the UAV or implementing flight response measures. For example, if there is a conflict in the database, the UAV will act according to the UAV database. Only the database of the UAV may be utilized in actually implementing flight response measures.

In some instances, the UAV may comprise one or more processing modules. The processing modules may be provided on-board the UAV. Alternatively or in addition, some of the processing modules may be provided off-board the UAV, e.g., at a ground terminal. The one or more processing modules of the UAV may comprise an application processing module 307 described herein. Alternatively or in addition, the one or more processing modules may comprise a flight control module 309, or other modules described herein.

The application processing module may be provided as a centerpiece for managing flight or operation related to the aerial vehicle. The application processing module may comprise one or more processors. For example, the application processing module may comprise one, two, three, four, five, six, seven, eight, nine, ten, or more processors. Each of the processors may be a single core or multi-core processor. An application processing module may also be referred to herein as an application processor.

In some instances, the application processing module may be configured to run an operating system. The operating system may be a general purpose operating system configured to run a plurality of other programs and applications, depending on mission requirements or user preference. In some instances, the applications that may run on the application processing module may relate to flight and/or control of the UAV. In some instances, external devices coupled to the application process module (e.g., via various interfaces provided) may load programs or applications which may be run on the application processing module. For examples, applications having to do with processing flight restricted region related information may be run on the application processing module. Accordingly, the application module may enable process of increased volume of data relating to flight restricted regions that comprise complex parameters (e.g., complicated shapes, flight response measures, etc.). In some instances, applications that may run on the UAV may be user configurable and/or updatable. Accordingly, the operating system may provide a means to update and/or add functionality to the UAV. In some instances, the operational capabilities of the UAV may be updated or increased with no hardware upgrades. In some instances, the operational capabilities of the UAV may be updated or increased only with a software update via the operating system. In some instances, the operating system may be a non-real time operating system. Alternatively, the operating system may be a real-time operating system. A real time operating system may be configured to respond to input (e.g., input data) instantly, or in real time. A non-real time operating system may respond to input with some delay. Examples of non-real time operating systems may include, but are not limited to, Android, Linux, Windows, etc.

In some instances, the application processing module may provide a plurality of interfaces for coupling, or connecting, to peripheral devices. The interfaces may be any type of interface and may include, but are not limited to USB, UART, I2C, GPIO, I2S, SPI, MIPI, HPI, HDMI, LVDS, and the like. The interface may comprise a number of characteristics. For example, the interface may comprise characteristics such as a bandwidth, latency, and/or throughput. In some instances, the peripheral devices may comprise additional sensors and/or modules. The peripheral devices may be coupled to the application processing module via specific interfaces depending on needs (e.g., bandwidth or throughput needs). In some instances, a high bandwidth interface (e.g., MIPI) may be utilized where high bandwidth is necessary (e.g., image data transmission). In some instances, a low bandwidth interface (e.g., UART) may be utilized where low bandwidth is necessary (e.g., control signal communication). As an example, a MIPI may be utilized for transmission of data between an application processing module and an image processing module. As an example, an HPI may be utilized for transmission of data between an application processing module and an image transmission module. As an example, a USB may be utilized for transmission of data between an application processing module and a real-time sensing module, or between an application processing module and a flight control module. As an example, a UART may be utilized for transmission of control signal, e.g., between the flight control module and image transmission module.

The interfaces may provide modularity to the UAV such that a user may update peripheral devices depending on mission requirements or preference. For example, depending on a user's needs and mission objectives, peripheral devices may be added or swapped in and out to enable a modular configuration that is best suited for the UAV objective. Peripheral devices may include, but are not limited to, imaging devices, auditory devices, projectile devices, mechanical devices, memories, batteries, and the like. In some instances, the plurality of interfaces may easily be accessible by a user. In some instances, the plurality of interfaces may be located within a housing of the UAV. Alternatively or in addition, the plurality of interfaces may be located in part, on an exterior of the UAV.

The application processing module may communicate with a flight control module 309 for efficient processing of data and implementation of UAV features. The flight control module, or flight controller, may optionally comprise a micro controller unit (MCU). The flight control module may be coupled to one or more ESC controllers. For example, the flight control module may be electronically coupled or connected to one or more ESC controllers. In some instances, the flight control module may be in direct communication with the ESC controllers and may be responsible for ultimate flight control of the UAV.

In some instances, the application processing module may intake data or information from the database 301 and further process data to generate useful information for flight of the UAV (e.g., grid map building). In some instances, the application processing module may intake data or information from the database 301 and further process data to generate useful information for flight of the UAV to the flight controller. For example, the application processing module may intake region information regarding the flight restricted regions and further divide the flight restricted regions into sub-regions that are more readily processed and analyzed. The dividing may be based on height restrictions, flight response measures, shapes of base portion, etc., as described above. As another example, the application processing module may intake region information regarding the flight restricted regions from the database, and process the region information of the flight restricted regions (or sub-regions) to obtain positional information of the flight restricted regions (or sub-regions) as further described below. Positional information may relate to positional information of the UAV to each flight restricted region (or sub-region) near the UAV. Alternatively or in addition, the application processing module may intake region information regarding the flight restricted regions from the database, and process the region information to obtain flight information of the flight restricted regions (or sub-regions) as further described below. The flight information may relate to a final flight instructions of the UAV relative to all flight restricted regions near the UAV. In some instances, the operating system run on the application processing module, as well as the various interfaces which enable an operator of the UAV to configure the UAV to operate with updated applications and/or devices (e.g., peripherals) may provide the UAV great modularity and configurability such that it is able to operate under conditions best suited for a given mission objective.

The flight control module may comprise one or more processors. For example, the flight control module may comprise one, two, three, four, five, six, seven, eight, nine, ten, or more processors. Each of the processors may be a single core or multi-core processor. In some instances, the flight control module may comprise an embedded processor such as a reduced instruction set computer (RISC). The RISC may operate at a high speed, performing more than millions of instructions per second (MIPS). The flight control module may be configured to process data in real time and with high reliability.

In some instances, the flight control module may be configured to effect functionalities or features of the UAV, e.g., by controlling movement of one or more propulsion units on board the UAV. For example, according to instructions or information received from other processing modules, the flight control module may affect movement of the UAV such that the features are implemented. In some instances, the flight control module may be configured to maintain a stable flight of the UAV. The flight control module may be configured to process information (e.g., information received from sensors coupled to the flight control module) such that stable flight of the UAV is maintained. In some instances, the flight control module may be sufficient to maintain flight of the UAV in the air, e.g., without functioning of the application processing module.

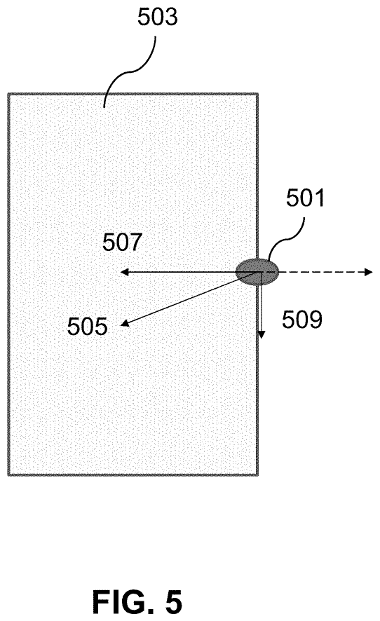

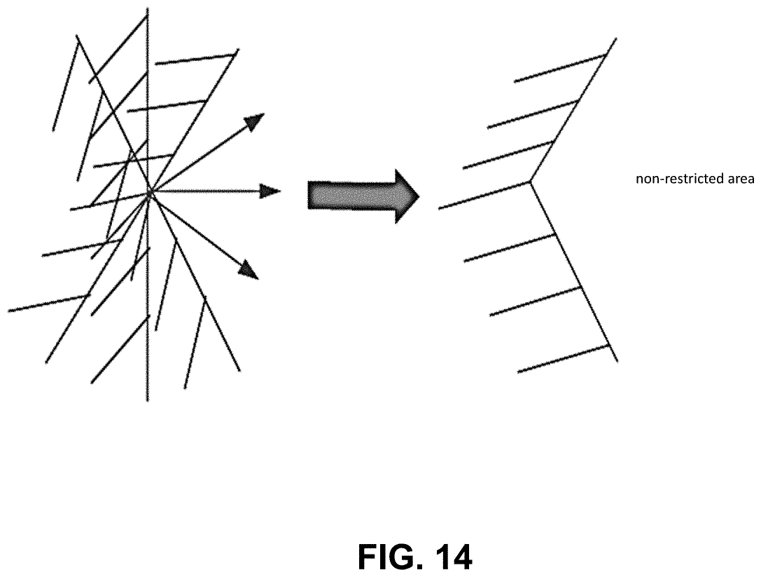

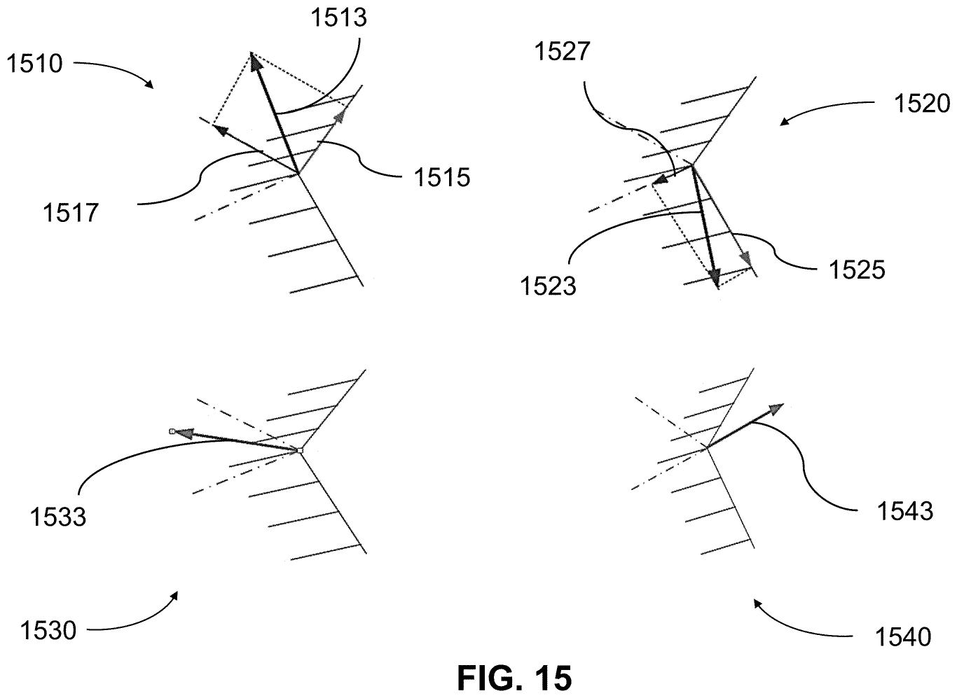

In some instances, the flight control module may intake positional information regarding the flight restricted regions from the application processing module, and process the positional information to obtain flight information of the flight restricted regions (or sub-regions) as further described below. The flight information may relate to a final flight instructions of the UAV relative to all flight restricted regions near the UAV. Alternatively or in addition, the flight control module may receive a final flight information from the application processor and merely implement the appropriate flight response measures. The flight information may comprise a flight direction (e.g., a directional vector) and a distance if the UAV is near (at a side of) the flight restricted regions. The flight information may comprise a height ceiling based on height restrictions of the flight restricted regions if the UAV is under a flight restricted region. FIG. 14 illustrates obtaining flight information based on positional information, in accordance with embodiments. As illustrated on the left side of FIG. 14, for a flight restriction region (or sub-region, base region, etc.), a plurality of directional vectors may be provided as part of positional information. The plurality of directional vectors may be processed, or added, and a resulting vector may be the flight direction. In some instances, based on the flight direction, a decomposer for decomposing an instruction to direct the UAV may be made. For example, if the instruction to direct the UAV (e.g., a speed instruction) is made that directs the UAV toward the direction of the flight restricted region, and the instruction has a component related to a non-restricted region, then the instruction may be decomposed in a manner to obtain a maximum norm of the component related to the non-restricted region while a component directed towards the flight restricted region may be eliminated, for example, as described below with respect to FIGS. 5 and 15.

The application processing module and the flight control module may comprise different processing modules configured to manage different operational aspects of the aerial vehicle. Providing for different processing modules may enable an efficient use of resources on board the UAV as the application processing module may act as a module of the UAV processing a large amount of data while the flight control module may ensure optimal operation (e.g., stable operation) of the UAV by processing some data (e.g., some received from the application processing module) where necessary or beneficial, in real time.

For example, the application processing module may process applications or tasks that require an extensive amount of processing power and. The flight control module may process information from sensors in order to maintain stable flight of the UAV and may affect directed and/or passive automated flight, e.g., by instructing ESC controllers to affect movement of one or more propulsion units.

The different processing modules may comprise different processing capabilities, e.g., as necessitated by their different functionalities. Processing capabilities as used herein may be measured by a clock speed and/or a floating-point operations per second capable by the different processing modules. In some instances, the processing power of the application processing module may be equal to or greater than about 10%, 15%, 20%, 25%, 40%, 60%, 80%, 100%, 125%, 150%, 175%, 200%, 250%, 300% or more than the processing power of the flight control module.

In some instances, the application processing module may obtain a location of the UAV, e.g., via a GPS coupled to the module. The application processing module may further process (e.g., calculate) a relationship between the UAV and a flight restricted area (e.g., flight restricted region or sub-region). In some instances, the application processing module may process positional information of flight restricted regions relative to a UAV. Optionally, the application processing module may process positional information of sub-regions (of the flight restricted regions) relative to a UAV. While positional information of flight restricted regions are primarily described herein, it is to be understood that any positional information described with respect to flight restricted regions are equally applicable to sub-regions of the flight restricted regions. Optionally, as sub regions may be simplified, positional information with respect to a given sub region may be more simplified and/or may comprise less data or information than positional information with respect to a flight restricted region. The positional information may comprise information regarding an identity of the flight restricted regions or sub-regions. The positional informational may comprise information regarding how many flight restricted regions or sub-regions are near, or surround the UAV. In some instances, the positional information may comprise a distance between the UAV and the flight-restricted region or sub-regions. The distance may be the shortest distance between the UAV and one edge of the flight-restricted regions or sub-regions at a side of the UAV in a horizontal direction. If the UAV is inside the flight-restricted area, the distance can be a negative value, or invalid. Optionally, when the UAV is under a flight restricted region or sub-region, the distance may not be utilized to effect flight of the UAV. Alternatively or in addition, the distance may be the shortest distance between the UAV and a flight ceiling or a flight floor of the flight restricted regions or sub-regions above or below the UAV in a vertical direction. If the UAV is at a side of a flight restricted region or sub-region in a horizontal direction, the distance can be a negative value, or invalid.

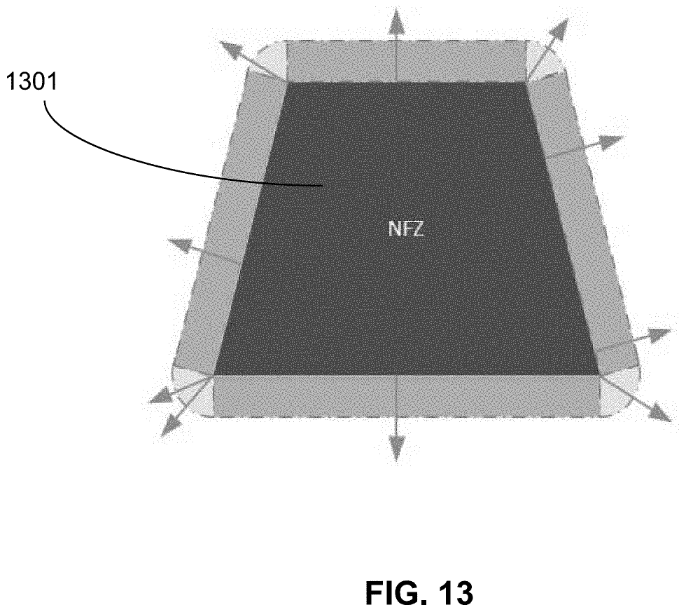

The positional information may alternatively or additionally comprise directional vectors. FIG. 13 illustrates an example of direction vectors generated for a flight restricted region 1301, in accordance with embodiments. Each arrow illustrated in the figure may represent a directional vector. To determine a line may be drawn from a location of a UAV to each edge (e.g., side) of the flight restricted region (represented by a polygon in FIG. 13). A line may also be drawn from the location of the UAV to a vertex of the flight restricted region. A length of each line may then be calculated. A shortest of the calculated lines may then be determined. If the shortest line is to a side, then the directional vector may be pointing from the side to the UAV. If the shortest line is to a vertex, the directional vector may be pointing from the vertex to the UAV. The directional vectors of the UAV relative to the flight-restricted regions or sub-regions may comprise unit vectors extending from the flight restricted region or sub-region at a side of the UAV to the UAV in a horizontal direction. For example, the directional vectors (e.g., arrows) illustrated in FIG. 13 may represent directional vectors. In FIG. 13, as the directional vectors point outward from the flight restricted region 1301, the UAV may be outside the flight restricted region. If the UAV were to be within the flight restricted region, then the direction of the directional vectors may be reversed (e.g., point inward). Optionally, when the UAV is under a flight restricted region or sub-region, the directional vector may not be utilized to effect flight of the UAV, or may be invalid. Alternatively or in addition, the positional information may comprise a plurality of direction vectors (or distances) of the UAV relative to a plurality of flight restricted regions or sub regions.

The positional information may also comprise whether the UAV is under a flight restricted region having a height restriction (e.g., height ceiling or floor). The positional information may alternatively or additionally comprise a height the UAV is allowed to fly to based on current coordinates of the UAV. For example, if the UAV is within a flight restricted region having a height limit, the height may be representative of the height that the UAV currently can reach and may be valid when the UAV is flying below this height. In some instances, the flight controller may be configured to determine whether to process a distance or direction vector to a flight restricted region located at a side (e.g., horizontally) relative to the UAV, or to process a height restriction the UAV is subject to based on whether the UAV is under a flight restricted region having the height restriction. Accordingly, for a given flight restricted region (or sub region), only a directional vector and distance, or a height restriction may be determined. Optionally, the positional information described herein may be processed for each flight restricted region or sub region located near (e.g., at a side or over, encompassing, etc.) the UAV.

In some instances, the application processing module may send positional information (e.g., relation of the UAV to the flight restricted region) to the flight control module. As used herein, positional information received by the flight control module may refer to positional information described above and/or further processed positional information (e.g., flight information). The flight control module may utilize the positional information to affect a flight of the UAV. The flight control module may further process the positional information with respect to two dimensions (e.g., a horizontal direction and a vertical direction) to affect flight of the UAV. The flight control module may process the positional information and determine a height that the flight restricted region can support the UAV. In some instances, the received positional information (e.g., whether or not it is further processed by the flight controller) may prevent the UAV from entering flight restricted regions. In some instances, the received positional information may force the UAV to land when the UAV is not within a predetermined distance from an outer edge of the flight restricted regions or sub regions. In some instances, the received positional information may force a UAV to leave a flight restricted region or sub regions when the UAV is within the regions. For example, the received positional information may force the UAV to land when the UAV has not left the flight restricted region or sub region within a predetermined time period. In some instances, the received positional information may provide a warning to a user of the UAV to land the UAV when the UAV is within the flight restricted region or sub region. The application processor and/or the flight controller may be located on board the UAV. Optionally, either the application processor and/or the flight controller may be located off board the UAV.

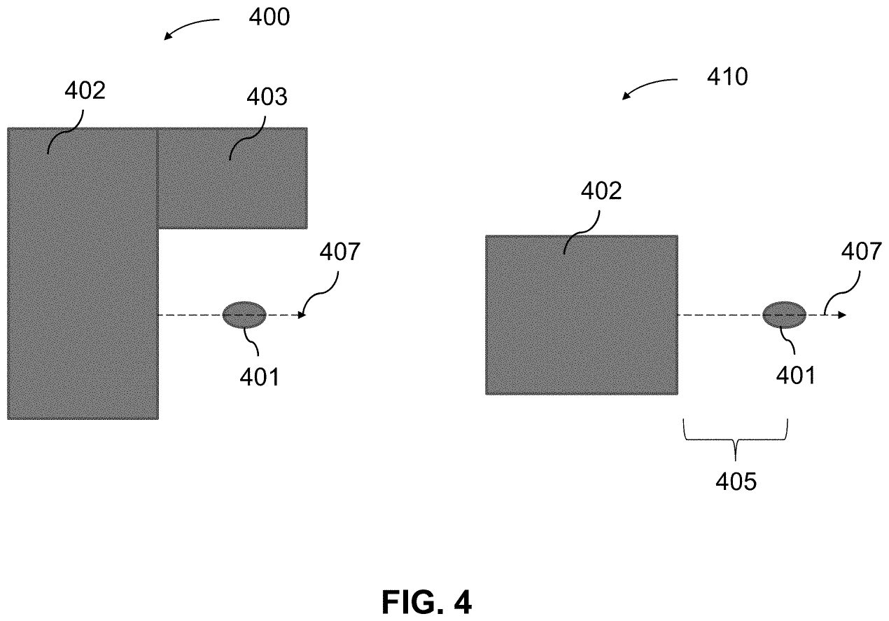

FIG. 4 illustrates a side view 400 and a bottom view 410 of a UAV 401 relative to flight restricted regions 402 and 403, in accordance with embodiments. Optionally, flight restricted regions 402 and 403 may also be an example of divided sub regions (e.g., a flight restricted region divided by an application processor based on a criteria, such as different height restrictions) to beneficially aid in processing. As described above, the flight control module may receive positional information of each of the flight restricted regions (or sub regions) 402 and 403 relative to the UAV 401 from an application processing module. The positional information may comprise a number of flight restricted regions. For example, the number of flight restricted regions may be two (stemming from flight restricted region 402 and 403). While positional information received for two flight restricted regions is described herein, it is to be understood that positional information may be received for any given number of flight restricted regions. For example, at least 2, 3, 4, 5, 6, 7, 8, 9, 10, 12, 14, 16, 18, 20, 24, 28, 32, 36, 40, 45, 50, 55, 60, 70, 80, 90, 100, or more flight restricted regions may be near a UAV, and positional information for each of those flight restricted regions may be processed by an application processing module, and received by a flight control module.

The positional information may comprise an identity (id) of the flight restricted regions. Each flight restricted region may have a unique id. For example, flight restricted region 402 may comprise an id of 01 while flight restricted region 403 may comprise an id of 02. The positional information may comprise a distance 405 from a nearby flight restricted region 402 to the UAV. The distance may be a horizontal distance, or a shortest distance measured horizontally from a nearby flight restricted region to the UAV. Accordingly, there may be no distance positional information of the flight restricted region 403 relative to the UAV as the UAV is located below the flight restricted region. The positional information may comprise a directional vector 407 to the UAV from the flight restricted region. The directional vector may be a vector pointing from a nearby flight restricted region 402 to the UAV along a horizontal axis. The directional vector may exist along an axis with a shortest distance between the flight restricted region and the UAV (e.g., measured along a horizontal axis). Accordingly, there may be no directional vector positional information of the flight restricted region 403 relative to the UAV as the UAV is located below the flight restricted region. The positional information may comprise a height 409 the UAV is allowed to fly. The height may be a height the UAV is allowed to fly upwards or downwards based on its height relative to a height ceiling or floor of the flight restricted region 403 above and/or below it. Accordingly, there may be no height positional information (or the height may be limitless) of the flight restricted region 402 relative to the UAV as the UAV is not located below or above the flight restricted region.

Utilizing the above described positional information, the flight control module may affect operation of the UAV such that the UAV is prevented from flying into the flight restricted region and/or prevented from flying within the flight restricted region. In some instances, a UAV may be prevented from flying into a flight restricted region by limiting a speed of the UAV (e.g., in a horizontal direction and/or in a vertical direction). In some instances, a buffer may be provided in a region near or between the flight restricted region and the UAV such that the UAV is not allowed to continue in a direction towards the flight restricted region at the buffer. Optionally, the UAV may be forced to gradually decrease in velocity when within the buffer and flying towards the flight restricted region.

In some instances, a UAV may be located within a flight restricted region. For example, a UAV may fly without a GPS signal and may suddenly get a GPS signal (e.g., when reaching a certain height). As another example, a UAV may fly within an indoor environment (e.g., with poor GPS signal) and fly to an outdoor area which is a flight restricted region. Accordingly, the UAV may find itself located within a flight restricted region. In such instances, the UAV may be stopped from flying within the flight restricted region. In some instances, the UAV may be stopped immediately from flying within the flight restricted region, and may be forced to land. Alternatively, the UAV may be given a predetermined time period to land and/or move out from the flight restricted region. The predetermined time period may be equal to or less than about 3 seconds, 5 seconds, 10 seconds, 15 seconds, 20 seconds, 25 seconds, 30 seconds, 35 seconds, 40 seconds, 45 seconds, 50 seconds, 55 seconds, or 60 seconds. Optionally, the UAV may be forced to land if a distance between the UAV an outer edge of the flight restricted region is greater than a predetermined value. In some instances, the predetermined value may be equal to or less than about 5 meters, 10 meters, 15 meters, 20 meters, 25 meters, 30 meters, 35 meters, 40 meters, 45 meters, 50 meters, 55 meters, 60 meters, 65 meters, 70 meters, 75 meters, 80 meters, 85 meters, 90 meters, 95 meters, or 100 meters. Optionally, if the UAV finds itself located within a flight restricted region, the UAV may immediately or after a given period of time implement the flight response measure of the flight restricted region.

FIG. 5 illustrates a UAV 501 behavior adjacent to a flight restricted region 503, in accordance with embodiments. The UAV may in some instances be directed in a direction 505 (e.g., by a user). The direction, or vector, may be decomposed along the axis of the directional vector 507 away from the flight restricted region, and a normal vector 509 to the directional vector. According to received positional information, the UAV may process that it is adjacent to the flight restricted region 503. According to the directional vector previously described herein, the UAV may process that it is being directed to venture into a flight restricted region. Accordingly, the direction to move the UAV along direction 507 may be eliminated and the UAV may be moved in direction 509, along an edge of the flight restricted region. Optionally, the UAV may follow the direction directed by the user as closely as possible without venturing into the flight restricted region.

FIG. 15 illustrates other various UAV behaviors in a vicinity of flight restricted regions, in accordance with embodiments. In situation 1510, a UAV may be instructed to proceed in direction 1513. The direction 1513 may be decomposed into component 1515 of the direction related to a non-restricted region and component 1517 of the direction related to the flight restricted region. In such instances, the component 1517 may be eliminated and the UAV may be instructed to follow only component 1515 related to a non-restricted region. In situation 1520, a UAV may be instructed to proceed in direction 1523. The direction 1523 may be decomposed into component 1525 of the direction related to a non-restricted region and component 1527 of the direction related to the flight restricted region. In such instances, the component 1527 may be eliminated and the UAV may be instructed to follow only component 1525 related to a non-restricted region. In situation 1530, a UAV may be instructed to proceed in direction 1533. The direction 1533 may not be decomposed into different components where a given directional component is related to a non-restricted region. In such instances, the direction 1533 may be eliminated and the UAV may not move in response to the instruction. In situation 1540, a UAV may be instructed to proceed in direction 1543. The direction 1543 points towards a non-restricted region. In such instances, the UAV may follow the initially given instructions to proceed in direction 1543.

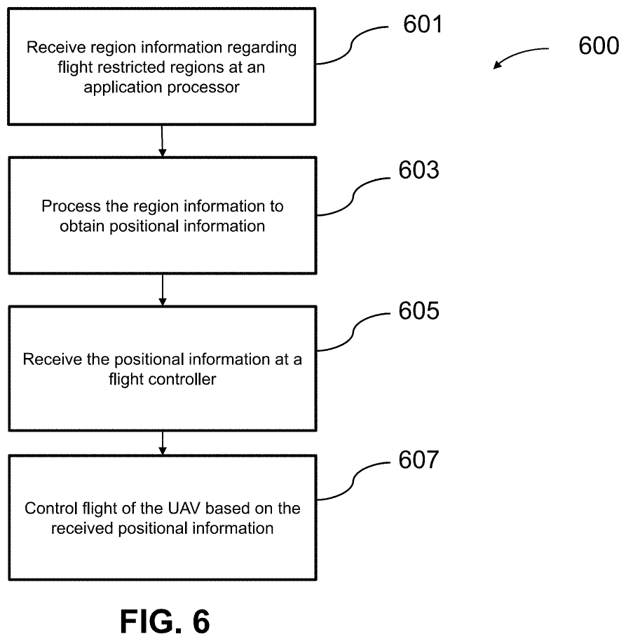

FIG. 6 illustrates a method for managing flight restricted regions for an unmanned aerial vehicle, in accordance with embodiments. The method may comprise a step 601 of receiving region information regarding the flight restricted regions from a database with aid of an application processor. The database may be hosted on a server. The region information may comprise various parameters regarding the flight restricted regions, substantially as described throughout. Optionally, the region information may comprise a simplified representation of a flight restricted region of the flight restricted regions near the UAV. In step 603, the region information may be processed by the application processor to obtain positional information of the flight restricted regions relative to the UAV. In instances where the region information comprises a simplified representation of a flight restricted region, the step may comprise accessing information regarding the flight restricted region corresponding to the simplified representation of the flight restricted region near the UAV. Accordingly, the simplified representation may be quickly searched for and once searched, relevant information (e.g., parameters, region information) of the actual flight restricted regions may be accessed. In some instances, processing the region information may comprise dividing a flight restricted region into a plurality of sub regions. Accordingly, if a flight restricted region has a complex shape, the flight restricted region may be divided according to a criteria for purposes of ease of processing by the application processor. For example, a large, complex flight restricted region may be divided according to height restrictions. Accordingly, the dividing may divide the flight restricted region into sub regions having different height restrictions. In some instances, the application processor may continue to subdivide the regions until each region can be defined by a flight restricted region having a circle or polygonal shape. As such, optionally, the method 600 may further comprise additionally dividing the sub regions having different height restrictions into base flight restricted regions. The base flight restricted regions may each comprise a base portion of simple shape (e.g., polygonal or circle shapes). Optionally, the application processor may in some instances aid in locating positional information of the UAV relative to each sub region (or base region). In some instances, the positional information may comprise a number of flight restricted regions near the UAV, an id of flight restricted regions near the UAV, and/or a distance between the UAV and the flight restricted regions. The distance may refer to a shortest distance between the UAV and one edge of a light restricted region near the UAV in a horizontal direction. Accordingly, when the UAV is flying below the flight restricted region near the UAV, the distance may be irrelevant and/or may not be utilized to effect flight of the UAV. Optionally, the positional information may comprise a directional vector of the UAV relative to the flight restricted regions. In some instances, when a flight restricted region has a complicated shape, the region may be subdivided into a plurality of regions as described throughout. Accordingly there may be a plurality of directional vectors that the UAV has to take into account, and that affects behavior of the UAV. The directional vector of the UAV may be a unit vector extending from a flight restricted region near the UAV to the UAV in a horizontal direction. When the UAV is flying below a flight restricted region, the directional vector may not be utilized by the flight controller to effect flight of the UAV. The positional information may also optionally comprise a height the UAV is allowed to fly to based on current coordinates of the UAV. The current coordinate may be a longitude and/or latitude of the UAV, or a location as determined by a GPS unit. When the UAV is flying outside of a flight restricted region (e.g., not below or above the region, but away horizontally from the region), the height may not be utilized to affect flight of the UAV. In step 605, a flight controller in communication with the application processor may receive the positional information of the flight restricted regions relative to the UAV. The flight controller may not receive any information regarding the flight restricted regions from the database, but may instead just receive the positional informational from the application processor having to do with whether the UAV is allowed to move in a horizontal direction and a vertical direction. In step 607, the flight controller may further control flight of the UAV based on the received position information. In some instances, the flight controller may be configured to derive flight information for the UAV by processing the received positional information before said controlling flight of the UAV. The flight information may comprise a directional vector and a distance if the UAV is near (at a side of) the flight restricted regions. The directional vector may be singular, having taken into account all directional vectors of each sub region. In some instances, the final flight information may comprise a height ceiling based on height restrictions of the flight restricted regions if the UAV is under a flight restricted region. In some instances, flight information may be derived by the application processor and may be transmitted to the flight controller. Accordingly, the positional information received by the flight controller may comprise flight information for the UAV. In such instances, the flight information may be as described above. Optionally, the flight controller may not receive or process flight restricted regions, but may instead simply receive instructions to effect flight of the UAV based on processed information, such as positional information.

In some instances, the method 600 may further comprise displaying the flight restricted regions on a mobile display. The mobile display may be configured to store information regarding the flight restricted regions, and may be a controller as referred throughout. The application processor and the flight controller referred above may or may not be located on board the UAV. The application processor and the flight controller together may implement a flight response measure of the UAV, according to received region information and/or positional information. For example, the received positional information may be used by the flight controller to prevent the UAV from entering flight restricted regions. If the UAV is already within the flight restricted regions, the received positional information may be used by the flight controller to force land the UAV. In some instances, the system may give the user to move out from the flight restricted region within a predetermined time period, or if the UAV is within a certain distance of an outer edge of the flight restricted region as described herein. Optionally, a warning may be provided to the user of the UAV when the UAV is within a flight restricted region.

In some instances, a flight restricted region may comprise a combination of sub regions. The combination of different flight restricted regions may comprise base portions which are polygonal, circular, or elliptical in shape. Optionally, the combination of different flight restricted regions may comprise different flight restriction heights. Alternatively or in addition, the combination of different flight restricted regions (or sub regions) may be overlapping.

In some instances, a system may be provided for implementing the method 600. The system may comprise an application processor configured to receive region information regarding a flight restricted region from a database. The application processor may further be configured to process the region information to obtain positional information of the flight restricted regions relative to the UAV based on the region information. The system may further comprise a flight controller in communication with the application processor. The flight controller may be configured to receive the positional information of the flight restricted regions relative to the UAV. The flight controller may be further configured to control flight of the UAV based on the received positional information.

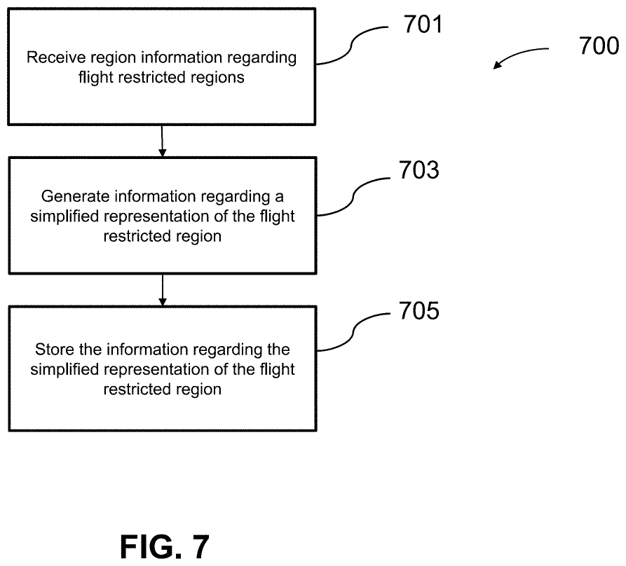

FIG. 7 illustrates a method 700 for storing simplified representations of flight restricted regions for an unmanned aerial vehicle, in accordance with embodiments. In step 701, region information regarding a flight restricted region may be received by one or more processors. Optionally, the information may be received from a database, such as a database described throughout (e.g., external database remote to the UAV). Alternatively or in addition, the database may be located on a memory on board the UAV. In some instances, the database is located on a mobile device external to the UAV. The one or more processors may be processors located on a remote location. Alternatively, the processors may be processors located on the UAV. In step 703, the region information may be processed to generate information regarding a simplified representation of the flight restricted region. The simplified representation of the flight restricted region may encompass the actual flight restricted region. For example, the simplified representation may comprise a circumscribed circle or a minimum covering circle covering the actual flight restricted region. The actual flight restricted region, in contrast, may be a complex shape, polygonal in shape, or may comprise a base portion in any shape described herein. In step 705, the information regarding the simplified representation of the flight restricted region may be stored in a database. The information regarding the simplified representation of the flight restricted region may comprise and/or require less data for storage than the information regarding the flight restricted region. In some instances, the database may be the database the region information is received from. Alternatively, the database may be an external database. In some instances, the database may be a database (e.g., memory) located on board a UAV. Optionally, the database may be located on a mobile device operably coupled to the UAV. The method 700 may further comprise utilizing the information regarding the flight restricted region to affect behavior of the UAV and/or components associated with the UAV. For example, the UAV may be prevented from entering the flight restricted region. As another example, a warning may be given to a user of the UAV when the UAV is within the flight restricted region. In some instances, the warning may be given by the UAV itself (e.g., via sound, light, etc.) or the warning may be given to a remote controller operably coupled to the UAV. Optionally, the user may be given a period of time to land the UAV when the UAV is within the flight restricted region.

In some instances, the information regarding the simplified flight restricted region may not be directly utilized in affecting behavior of the UAV. For example, if a UAV is within an area encompassed by the simplified representation of the flight restricted region but outside of the actual flight restricted region, the UAV's behavior will be unaffected. Accordingly, the simplified representation of the flight restricted region may be utilized for other purposes, e.g., other purposes than affecting behavior of the UAV. For example, the simplified representation may allow for a quick search of nearby flight restricted regions without having to process parameters relating to the actual flight restricted regions, which may be necessitate large processing resources and/or may require large storage requirements for data.

In some instances, a system may be provided for implementing the method 700. The system may comprise one or more processors configured to receive region information regarding a flight restricted region. The one or more processors may further be configured to process the region information to obtain information regarding a simplified representation of the flight restricted region. The system may further comprise a database. The database may be configured to receive the information regarding the simplified representation of the flight restricted region, and store the information regarding the simplified representation of the flight restricted region.

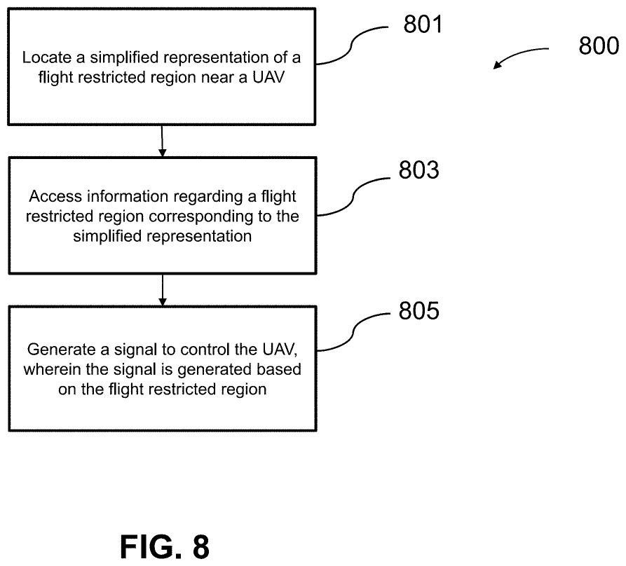

FIG. 8 illustrates a method 800 for managing flight restricted regions for an unmanned aerial vehicle, in accordance with embodiments. In step 801, a simplified representation of a flight restricted region (e.g., as described in FIG. 7) near a UAV may be located in a database with aid of one or more processors. For example, this locating step may be done concurrently while processing a location of the UAV (e.g., based on GPS coordinates) to search for nearby flight restricted regions. The database may be the database as described with respect to FIG. 7. Once the nearby flight restricted regions are located, information regarding an actual flight restricted region corresponding to the simplified representation of the flight restricted region near the UAV may be accessed in step 803. In step 805, a signal may be generated to control the UAV or a remote controller operably coupled to the UAV. The signal may be generated based on the flight restricted region, and not based on the simplified representation of the flight restricted region. The signal may in some instances be configured to control one or more propulsion units of the UAV to effect the UAV to act in accordance with the flight restricted region. In some instances, the signal may prevent the UAV from entering the flight restricted region. Alternatively or in addition, the signal may force the UAV to land when the UAV is within the flight restricted region. Optionally, the signal may force the UAV to land after a predetermined time period if the UAV is still within the flight restricted region. Optionally, the signal may force the UAV to land if the UAV is more than a predetermined distance away from an edge of the flight restricted region. In some instances, the signal may be configured to control the mobile controller operably coupled to the UAV to effect the UAV to act in accordance with the flight restricted region. For example, the signal may be configured to provide a warning on the mobile controller when the UAV is near or within the flight restricted region. As the simplified flight restricted region may encompass the actual flight restricted region, the UAV's behavior may be unaffected in a region within the simplified flight restricted region and outside of the actual flight restricted region.

In some instances, a system may be provided for implementing the method 800. The system may comprise one or more processors configured to locate, in a database, a simplified representation of a flight restricted region near the UAV. The one or more processors may further be configured to access information regarding a flight restricted region corresponding to the simplified representation of the flight restricted region near the UAV, and generate a signal to control the UAV or a remote controller operably coupled to the UAV. The signal may be generated based on the flight restricted region (e.g., such that the UAV does not go into the flight restricted region), but not based on the simplified representation of the flight restricted region (e.g., such that the UAV may go into an area covered by the simplified representation).

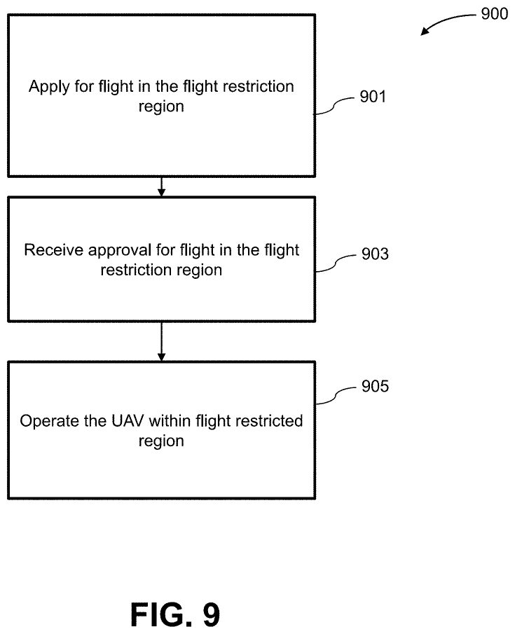

FIG. 9 provides a method 900 of operating a UAV in a flight restricted region, in accordance with embodiments. In step 901, flight in the flight restricted region may be applied for. For example, the request may be made with aid of a remote controller, or a user terminal. The user terminal may be, for example, a mobile device, such as a cell phone, PDA, or tablet. The user terminal may be, for example, a remote controller. The user terminal may comprise a display unit. The display unit may display flight restricted regions on a user interface (e.g., two-dimensional or three-dimensional representation of flight restricted regions on a map). The user interface may be accessed through an application or a website. The user interface may be interactive. For example, a UAV operator may select a flight restricted region on the user interface via pointer selection (e.g., mouse pointer) or finger touch and apply for flight within the region.

Optionally, applying for flight in the flight restricted region may include applying for a permitted flight time. The permitted flight time may be temporary, or indefinite. For example, the permitted flight time may be about or less than 1 minute, 2 minute, 5 minutes, 10 minutes, 15 minutes, 30 minutes, 60 minutes, 120 minutes, 180 minutes, 6 hours, 12 hours, 1 day, 1 week, 1 month, or indefinite. Applying for flight in the flight restricted region may include applying for a permitted flight region. The permitted flight region may be defined by a three-dimensional shape. The permitted flight region may be equal to the whole flight restricted region. The permitted flight region may be a subset of the flight restricted region (e.g., smaller than the flight restricted region). For example, the region within the flight restricted region may be defined as how a complex flight restricted region may be divided (e.g., by an application processor of the UAV). For example, the flight restricted region may be divided based on height, etc., substantially as described herein.

Optionally, applying for flight in the flight restricted region may include applying for a permitted flight response measure. For example, a UAV operator may propose a permitted flight measure to be subject to while within the flight restricted region. The permitted flight response measure may be selected from a list of flight response measures. The permitted flight response measure may be selected automatically with aid of one or more processors, without requiring use input. In some instances, some user input may be provided, but one or more processors may make the final determination of the flight response measures. For example, a UAV operator may propose to fly above a certain altitude while in the flight restricted region. For example, a UAV operator may propose to turn off sensors on the UAV while in the flight restricted region.

In step 903, approval for flight in the flight restricted region may be received. For example, the approval may be received at the user terminal. The approval may be given by a third party. The third party may be a person that exercises control over the flight restricted region. The third party may be a person associated with the database. If a permitted flight region, permitted flight time, or permitted flight response measure had been applied for in step 901, the third party may accept (e.g., approve) or reject. If a permitted flight region, permitted flight time, or permitted flight response measure had been applied for in step 901, the third party may accept but designate its own permitted flight time, permitted flight region, and/or permitted flight response measure. If no permitted flight region or permitted flight time had been applied for in step 901, the third party may accept or reject. If no permitted flight region or permitted flight time had been applied for in step 901, the third party may accept but designate its own permitted flight time, permitted flight region, and/or permitted flight response measure. Receiving an approval may comprise receiving a notification of approval. For example, the user terminal may send an alert that an approval was received. The alert may be visual, tactile, auditory, and the like.

Optionally, an approval region and an approval time may be determined with aid of one or more processors. For example, the one or more processors may determine the approval region to be equal a permitted flight region (either applied for with aid of a user terminal, or offered by the third party). For example, if no approval region had been applied been applied for or offered by the third party, the one or more processors may determine the approval region (e.g., from a predetermined list, according to preset configurations, according to conditions, etc.). The approval region may be defined by a three-dimensional shape. The approval region may be a subsection of the flight restricted region (e.g., smaller than the flight restricted region). For example, the one or more processors may determine the approval time to be equal a permitted flight time (either applied for with aid of a user terminal, or offered by the third party). For example, if no approval time had been applied been applied for or offered by the third party, the one or more processors may determine the approval time (e.g., from a predetermined list, according to preset configurations, according to conditions, etc.). The approval time may be about or less than 1 minute, 2 minute, 5 minutes, 10 minutes, 15 minutes, 30 minutes, 60 minutes, 120 minutes, 180 minutes, 6 hours, 12 hours, 1 day, 1 week, 1 month, or indefinite. Optionally, once a flight restricted region is approved, the database (e.g., local database of the UAV, located on a server, etc.) may be updated such that the region information regarding the flight restricted region is updated.

In step 905, the UAV may be operated within the flight restricted region, e.g., according to the region applied for. If a permitted flight response measure had been applied for and approved of, or designated, the UAV may operate under the permitted flight response measures. The user terminal may send a signal to the UAV conveying the approval time and/or the approval region. The UAV may send a confirmation back to the user terminal that the approval time and/or the approval region was received. A UAV operating outside the approval region and/or outside the approval time may be subject to one or more flight response measures associated with the flight restricted regions. For example, if the approval time expires while the UAV is within the approval region, the UAV may automatically descend and land. Alternatively, the UAV may automatically fly away from the flight restricted region. For example, if the UAV flies outside of the approval region (but is still within the flight restricted region), the UAV may automatically descend and land, the UAV operator may receive warning signals, etc.

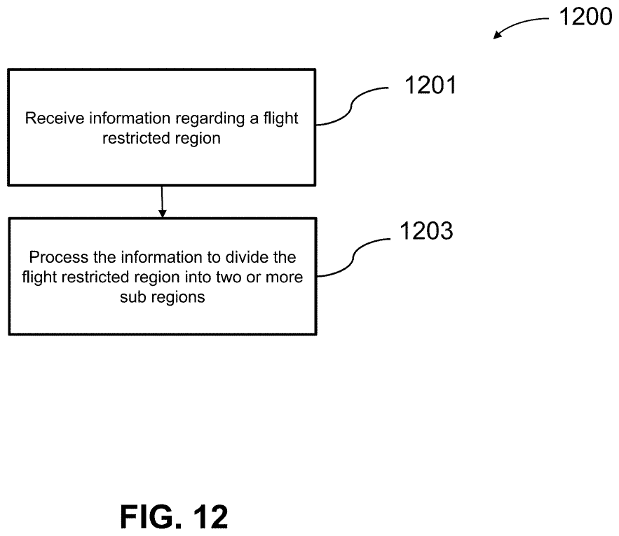

FIG. 12 illustrates a method for dividing a flight restricted region for an unmanned aerial vehicle (UAV), in accordance with embodiments. In step 1201, information regarding the flight restricted region may be received from a database. The flight restricted region may comprise a plurality of height restrictions. In some instances, the flight restricted region may comprise a complex shape, such that it is not merely circular or polygonal. In some instances, the information may be received with aid of an application processor. The application processor may be located on board the UAV. Alternatively, the application processor may be provided remotely (off board) to the UAV. Optionally, the application processor may be removably coupled to the UAV. In such instances, an application processor capable of dividing a complex flight restricted region into two or more sub regions may be provided as a kit to be coupled to a UAV, so as to upgrade the UAV with new capabilities.

In step 1203, the information may be processed to divide the flight restricted region into two or more sub regions, substantially as described throughout. For example, if the flight restricted region comprises a plurality of different height restrictions, the two or more sub regions may be divided based on the differing height restrictions. Alternatively or in addition, if the flight restricted region comprises a complex shape, the two or more sub regions may be divided to make each sub region a simple shape (e.g., circular or polygonal shape). Accordingly, step 1203 may comprise dividing the flight restricted region into the two or more sub regions, wherein each of the two or more sub regions comprise a base portion in a simple shape, such as a regular shape (e.g., circular or polygonal shape). The information regarding each of the two or more sub regions may comprise less data than the information regarding the flight restricted region. Optionally, a combination of the information regarding the two or more sub regions may substantially reproduce the information regarding the flight restricted region.

Optionally, the method 1200 may further comprise storing the information regarding the two or more sub regions. In some instances, the storing may be done with aid of the application processor. The storing may be done at a memory unit located on or off board the UAV. Optionally, the method 1200 may further comprise receiving, at a flight controller, the positional information of the two of more sub regions relative to the UAV. For example, the application processor may process the positional information of each of the two or more sub regions relative to the UAV and further transmit the positional information (or further processed flight information) to the flight controller. In such instances, the flight controller may further control flight of the UAV based on the received positional information. Optionally, the flight controller may calculate flight information (e.g., final flight information) for the UAV based on the received positional information. The flight information may comprise a directional vector and a distance if the UAV is at a side of the two or more sub regions. The flight information may alternatively or additionally comprise a height restriction (e.g., height ceiling or height floor) based on the height restrictions of the two or more sub regions if the UAV is under or over the two or more sub regions.

In some instances, a system may be provided for implementing the method 1200. The system may comprise an application processor configured to receive information regarding the flight restricted region from a database. The application processor may be further configured or programmed to process the information regarding the flight restricted region to generate information regarding two or more sub regions. The information regarding each of the two or more sub regions may comprise less data than the information regarding the flight restricted region. Optionally, a combination of the information regarding the two or more sub regions may substantially reproduce the information regarding the flight restricted region.

The systems, devices, and methods described herein can be applied to a wide variety of movable objects. As previously mentioned, any description herein of an aerial vehicle may apply to and be used for any movable object. A movable object of the present disclosure can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle; a movable structure or frame such as a stick, fishing pole; or a train), under the ground (e.g., a subway), in space (e.g., a spaceplane, a satellite, or a probe), or any combination of these environments. The movable object can be a vehicle, such as a vehicle described elsewhere herein. In some embodiments, the movable object can be mounted on a living subject, such as a human or an animal. Suitable animals can include avines, canines, felines, equines, bovines, ovines, porcines, delphines, rodents, or insects.

The movable object may be capable of moving freely within the environment with respect to six degrees of freedom (e.g., three degrees of freedom in translation and three degrees of freedom in rotation). Alternatively, the movement of the movable object can be constrained with respect to one or more degrees of freedom, such as by a predetermined path, track, or orientation. The movement can be actuated by any suitable actuation mechanism, such as an engine or a motor. The actuation mechanism of the movable object can be powered by any suitable energy source, such as electrical energy, magnetic energy, solar energy, wind energy, gravitational energy, chemical energy, nuclear energy, or any suitable combination thereof. The movable object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof. Alternatively, the movable object may be carried by a living being.

In some instances, the movable object can be a vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the movable object to take off from a surface, land on a surface, maintain its current position and/or orientation (e.g., hover), change orientation, and/or change position.

The movable object can be controlled remotely by a user or controlled locally by an occupant within or on the movable object. In some embodiments, the movable object is an unmanned movable object, such as a UAV. An unmanned movable object, such as a UAV, may not have an occupant onboard the movable object. The movable object can be controlled by a human or an autonomous control system (e.g., a computer control system), or any suitable combination thereof. The movable object can be an autonomous or semi-autonomous robot, such as a robot configured with an artificial intelligence.

The movable object can have any suitable size and/or dimensions. In some embodiments, the movable object may be of a size and/or dimensions to have a human occupant within or on the vehicle. Alternatively, the movable object may be of size and/or dimensions smaller than that capable of having a human occupant within or on the vehicle. The movable object may be of a size and/or dimensions suitable for being lifted or carried by a human. Alternatively, the movable object may be larger than a size and/or dimensions suitable for being lifted or carried by a human. In some instances, the movable object may have a maximum dimension (e.g., length, width, height, diameter, diagonal) of less than or equal to about: 2 cm, 5 cm, 10 cm, 50 cm, 1 m, 2 m, 5 m, or 10 m. The maximum dimension may be greater than or equal to about: 2 cm, 5 cm, 10 cm, 50 cm, 1 m, 2 m, 5 m, or 10 m. For example, the distance between shafts of opposite rotors of the movable object may be less than or equal to about: 2 cm, 5 cm, 10 cm, 50 cm, 1 m, 2 m, 5 m, or 10 m. Alternatively, the distance between shafts of opposite rotors may be greater than or equal to about: 2 cm, 5 cm, 10 cm, 50 cm, 1 m, 2 m, 5 m, or 10 m.

In some embodiments, the movable object may have a volume of less than 100 cm×100 cm×100 cm, less than 50 cm×50 cm×30 cm, or less than 5 cm×5 cm×3 cm. The total volume of the movable object may be less than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³. Conversely, the total volume of the movable object may be greater than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³.

In some embodiments, the movable object may have a footprint (which may refer to the lateral cross-sectional area encompassed by the movable object) less than or equal to about: 32,000 cm², 20,000 cm², 10,000 cm², 1,000 cm², 500 cm², 100 cm², 50 cm², 10 cm², or 5 cm². Conversely, the footprint may be greater than or equal to about: 32,000 cm², 20,000 cm², 10,000 cm², 1,000 cm², 500 cm², 100 cm², 50 cm², 10 cm², or 5 cm².

In some instances, the movable object may weigh no more than 1000 kg. The weight of the movable object may be less than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg. Conversely, the weight may be greater than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg.

In some embodiments, a movable object may be small relative to a load carried by the movable object. The load may include a payload and/or a carrier, as described in further detail below. In some examples, a ratio of a movable object weight to a load weight may be greater than, less than, or equal to about 1:1. In some instances, a ratio of a movable object weight to a load weight may be greater than, less than, or equal to about 1:1. Optionally, a ratio of a carrier weight to a load weight may be greater than, less than, or equal to about 1:1. When desired, the ratio of an movable object weight to a load weight may be less than or equal to: 1:2, 1:3, 1:4, 1:5, 1:10, or even less. Conversely, the ratio of a movable object weight to a load weight can also be greater than or equal to: 2:1, 3:1, 4:1, 5:1, 10:1, or even greater.

In some embodiments, the movable object may have low energy consumption. For example, the movable object may use less than about: 5 W/h, 4 W/h, 3 W/h, 2 W/h, 1 W/h, or less. In some instances, a carrier of the movable object may have low energy consumption. For example, the carrier may use less than about: 5 W/h, 4 W/h, 3 W/h, 2 W/h, 1 W/h, or less. Optionally, a payload of the movable object may have low energy consumption, such as less than about: 5 W/h, 4 W/h, 3 W/h, 2 W/h, 1 W/h, or less.

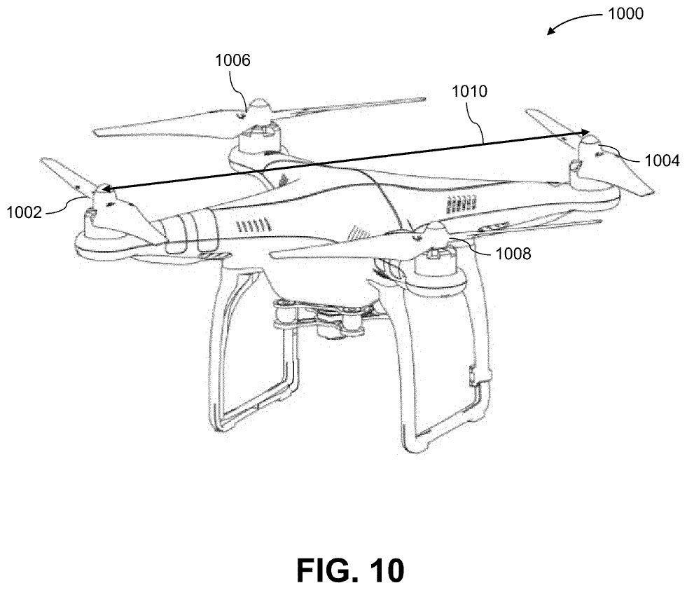

FIG. 10 illustrates an unmanned aerial vehicle (UAV) 1000, in accordance with embodiments. The UAV may be an example of a movable object as described herein, to which the method and apparatus of discharging a battery assembly may be applied. The UAV 1000 can include a propulsion system having four rotors 1002, 1004, 1006, and 1008. Any number of rotors may be provided (e.g., one, two, three, four, five, six, or more). The rotors, rotor assemblies, or other propulsion systems of the unmanned aerial vehicle may enable the unmanned aerial vehicle to hover/maintain position, change orientation, and/or change location. The distance between shafts of opposite rotors can be any suitable length 1010. For example, the length 1010 can be less than or equal to 2 m, or less than equal to 5 m. In some embodiments, the length 1010 can be within a range from 40 cm to 1 m, from 10 cm to 2 m, or from 5 cm to 5 m. Any description herein of a UAV may apply to a movable object, such as a movable object of a different type, and vice versa. The UAV may use an assisted takeoff system or method as described herein.

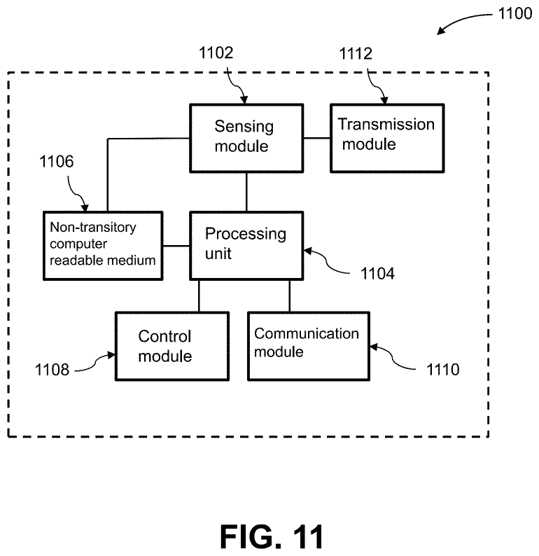

FIG. 11 is a schematic illustration by way of block diagram of a system 1100 for controlling a movable object. The system 1100 may be an example of a simplified UAV hardware architecture without distinction between different processing modules described herein. The system 1100 can include a sensing module 1102, processing unit 1104, non-transitory computer readable medium 1106, control module 1108, and communication module 1110.

The sensing module 1102 can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module 1102 can be operatively coupled to a processing unit 1104 having a plurality of processors. In some embodiments, the sensing module can be operatively coupled to a transmission module 1112 (e.g., a Wi-Fi image transmission module) configured to directly transmit sensing data to a suitable external device or system. For example, the transmission module 1112 can be used to transmit images captured by a camera of the sensing module 1102 to a remote terminal.

The processing unit 1104 can have one or more processors, such as a programmable processor (e.g., a central processing unit (CPU)). The processing unit 1104 can be operatively coupled to a non-transitory computer readable medium 1106. The non-transitory computer readable medium 1106 can store logic, code, and/or program instructions executable by the processing unit 1104 for performing one or more steps. The non-transitory computer readable medium can include one or more memory units (e.g., removable media or external storage such as an SD card or random access memory (RAM)). In some embodiments, data from the sensing module 1102 can be directly conveyed to and stored within the memory units of the non-transitory computer readable medium 1106. The memory units of the non-transitory computer readable medium 1106 can store logic, code and/or program instructions executable by the processing unit 1104 to perform any suitable embodiment of the methods described herein. For example, the processing unit 1104 can be configured to execute instructions causing one or more processors of the processing unit 1104 to analyze sensing data produced by the sensing module. The memory units can store sensing data from the sensing module to be processed by the processing unit 1104. In some embodiments, the memory units of the non-transitory computer readable medium 1106 can be used to store the processing results produced by the processing unit 1104.

In some embodiments, the processing unit 1104 can be operatively coupled to a control module 1108 configured to control a state of the movable object. For example, the control module 1108 can be configured to control the propulsion mechanisms of the movable object to adjust the spatial disposition, velocity, and/or acceleration of the movable object with respect to six degrees of freedom. Alternatively or in combination, the control module 1108 can control one or more of a state of a carrier, payload, or sensing module.

The processing unit 1104 can be operatively coupled to a communication module 1110 configured to transmit and/or receive data from one or more external devices (e.g., a terminal, display device, or other remote controller). Any suitable means of communication can be used, such as wired communication or wireless communication. For example, the communication module 1110 can utilize one or more of local area networks (LAN), wide area networks (WAN), infrared, radio, Wi-Fi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module 1110 can transmit and/or receive one or more of sensing data from the sensing module 1102, processing results produced by the processing unit 1104, predetermined control data, user commands from a terminal or remote controller, and the like.

The components of the system 1100 can be arranged in any suitable configuration. For example, one or more of the components of the system 1100 can be located on the movable object, carrier, payload, terminal, sensing system, or an additional external device in communication with one or more of the above. Additionally, although FIG. 11 depicts a single processing unit 1104 and a single non-transitory computer readable medium 1106, one of skill in the art would appreciate that this is not intended to be limiting, and that the system 1100 can include a plurality of processing units and/or non-transitory computer readable media. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system 1100 can occur at one or more of the aforementioned locations.

As used herein A and/or B encompasses one or more of A or B, and combinations thereof such as A and B. It will be understood that although the terms “first,” “second,” “third” etc. may be used herein to describe various elements, components, regions and/or sections, these elements, components, regions and/or sections should not be limited by these terms. These terms are merely used to distinguish one element, component, region or section from another element, component, region or section. Thus, a first element, component, region or section discussed below could be termed a second element, component, region or section without departing from the teachings of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the figures. It will be understood that relative terms are intended to encompass different orientations of the elements in addition to the orientation depicted in the figures. For example, if the element in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the element in one of the figures were turned over, elements described as “below” or “beneath” other elements would then be oriented “above” the other elements. The exemplary terms “below” or “beneath” can, therefore, encompass both an orientation of above and below.

While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

What is claimed is:

1. A method for managing flight restricted regions for an unmanned aerial vehicle (UAV), the method comprising:
with aid of an application processor,
receiving region information regarding the flight restricted regions from a database; and
processing the region information to obtain positional information of the flight restricted regions relative to the UAV; and
with aid of a flight controller in communication with the application processor,
receiving the positional information of the flight restricted regions relative to the UAV; and
controlling flight of the UAV based on the received positional information.

2. The method of claim 1, wherein the region information comprises information regarding one or more sub regions of the flight restricted regions.

3. The method of claim 2, wherein the one or more sub regions comprise a base portion in a regular shape.

4. The method of claim 1, wherein the positional information comprises information regarding one or more flight restricted regions near the UAV and/or one or more sub regions of the flight restricted regions near the UAV.

5. The method of claim 4, wherein the one or more sub regions comprise a base portion in a regular shape.

6. The method of claim 4, wherein a given flight restricted region of the flight restricted regions is divided into two or more sub regions by the application processor.

7. The method of claim 4, wherein the positional information comprises information regarding how many flight restricted regions and/or sub regions are near the UAV.

8. The method of claim 4, wherein the positional information comprises an identifier (ID) of flight restricted region or sub region near the UAV.

9. The method of claim 4, wherein the positional information comprises a distance between the UAV and the flight restricted region or sub region.

10. The method of claim 9, wherein the distance is a shortest distance between the UAV and one edge of a flight restricted region or sub region at a side of the UAV in a horizontal direction.

11. The method of claim 10, wherein when the UAV is under the flight restricted region or sub region, the distance is not utilized to effect flight of the UAV.

12. The method of claim 4, wherein the positional information comprises a directional vector of the UAV relative to the flight restricted region or sub region.

13. The method of claim 12, wherein the directional vector of the UAV is a unit vector extending from a flight restricted region or sub region at a side of the UAV to the UAV in a horizontal direction.

14. The method of claim 12, wherein when the UAV is under the flight restricted region or sub region, the directional vector is not utilized to effect flight of the UAV.

15. The method of claim 12, wherein the positional information comprises a plurality of directional vectors of the UAV relative to a plurality of flight restricted regions or sub regions.

16. The method of claim 4, wherein the positional information comprises a height, to which the UAV is allowed to fly, based on current coordinates of the UAV.

17. The method of claim 4, wherein the positional information comprises whether the UAV is under a flight restricted region or a sub region having a height restriction.

18. The method of claim 17, further comprising, with aid of the flight controller, determining whether to process a distance or directional vector to a flight restricted region or a sub region located horizontally relative to the UAV, or to process the height restriction, to which the UAV is subject, based on whether the UAV is under the flight restricted region or the sub region having the height restriction.

19. The method of claim 1, wherein the flight controller does not receive or process the flight restricted regions.

20. A system for managing flight restricted regions for an unmanned aerial vehicle (UAV), the system comprising:
an application processor configured to:
receive region information regarding the flight restricted regions from a database; and
process the region information to obtain positional information of the flight restricted regions relative to the UAV based on the region information; and
a flight controller in communication with the application processor, wherein the flight controller is configured to:
receive the positional information of the flight restricted regions relative to the UAV; and
control flight of the UAV based on the received positional information.
